(19) United States
(12) Patent Application Publication
(10) Pub. No.: US 2013/0121419 A1
(43) Pub. Date: May 16, 2013

(54) TEMPORAL LUMINANCE VARIATION DETECTION AND CORRECTION FOR HIERARCHICAL LEVEL FRAME RATE CONVERTER

(71) Applicants: Chon-Tam Le Dinh, Montreal (CA); Dinh Kha Le, Montreal (CA); Phuc-Tue Le Dinh, Montreal (CA); David R. Hansen, Toronto (CA)

(72) Inventors: Chon-Tam Le Dinh, Montreal (CA); Dinh Kha Le, Montreal (CA); Phuc-Tue Le Dinh, Montreal (CA); David R. Hansen, Toronto (CA)

(73) Assignee: QUALCOMM Incorporated, San Diego, CA (US)

(21) Appl. No.: 13/548,483

(22) Filed: Jul. 13, 2012

Related U.S. Application Data
(60) Provisional application No. 61/560,755, filed on Nov. 16, 2011.

(51) Int. Cl. H04N 7/36

(52) U.S. Cl. 375/240.16; 375/E07.123

(57) ABSTRACT

Systems and methods for the reduction of motion compensation artifacts in a standard or high resolution image interpolation, more specifically to temporal luminance variation, are described. In one innovative aspect, a method of correcting temporal luminance variation (TLV) artifacts during frame rate conversion is provided. The method includes detecting TLV between a first image and a second image based on edge information, TLV characteristics, and motion estimation information. The method further includes determining the location of TLV artifacts in an interpolated image between the first image and the second image. The method also includes modifying the interpolated image based on the determination.

### CROSS-REFERENCE TO RELATED APPLICATIONS

This application claims priority from U.S. Provisional Patent Application No. 61/560,755, entitled “Temporal Luminance Variation Detection and Correction in a Hierarchical Level Frame Rate Converter,” filed Nov. 16, 2011, which is incorporated by reference in its entirety.

The present application is also related to U.S. patent application Ser. No. 12/338,960, entitled “Motion Estimation with Adaptive Search Range,” filed Dec. 18, 2008 which is herein incorporated by reference in its entirety. The present application is also related to U.S. patent application Ser. No. 12/338,954, entitled “Image Interpolation with Halo Reduction,” filed Dec. 18, 2008 which is herein incorporated by reference in its entirety. The present application is further related to U.S. patent application Ser. No. 12/761,214, entitled “High Definition Frame Rate Conversion,” filed Apr. 15, 2010 which is herein incorporated by reference in its entirety.

### BACKGROUND

1. Field

The present invention relates to reduction of motion compensation artifacts in a standard or high resolution image interpolation, more specifically to temporal luminance variation.

2. Background

Image interpolation based on motion compensation is a technique for frame rate conversion (FRC). FRC which may be utilized to increase the refresh rate in video. In such applications, motion appears more fluid and the high refresh rate may yield more suitable images, for example, for display via LCD panels.

To create an intermediate image at a given temporal position between two existing images, FRC may include motion compensated (MC) interpolation techniques which are based in turn on motion vector (MV) estimation, for short referred as motion estimation (ME). Generally, artifacts can be introduced into the image through this process that may degrade the image in the FRC process.

Therefore, there is a need to provide local/global detection and better correction of artifacts in performing FRC operations.

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description” one will understand how the features of this invention provide advantages that include decreasing the size of a frame header of a data packet, thereby reducing the overhead in transmitting payloads in data packets.

In one innovative aspect, a method of correcting temporal luminance variation (TLV) artifacts during frame rate conversion is provided. The method includes detecting TLV between a first image and a second image based on edge information, TLV characteristics, and motion estimation information. The method further includes determining the location of TLV artifacts in an interpolated image between the first image and the second image. The method also includes modifying the interpolated image based on the determination.

In another innovative aspect, an apparatus for correcting temporal luminance variation (TLV) artifacts during frame rate conversion is provided. The apparatus includes a TLV detector configured to detect TLV between a first image and a second image based on edge information, TLV characteristics, and motion estimation. The apparatus further includes a TLV localizer configured to determine the location of TLV artifacts in an interpolated image between the first image and the second image. The apparatus also includes an image modifier configured to modify the interpolated image based on the determination.

In a further innovative aspect, a computer readable storage medium comprising instructions executable by a processor of an apparatus is provided. The instructions cause the apparatus to detect TLV between a first image and a second image during based on factors based on frame rate conversion information, the factors including edge information, TLV characteristics, and motion estimation information. The instructions cause the apparatus to determine the location of TLV artifacts in an interpolated image between the first image and the second image. The instructions cause the apparatus to modify the interpolated image based on the determination.

An additional innovative apparatus for correcting temporal luminance variation (TLV) artifacts during frame rate conversion is provided. The apparatus includes means for TLV detection configured to detect TLV between a first image and a second image based on edge information, TLV characteristics, and motion estimation. The apparatus includes means for TLV localization configured to determine the location of TLV artifacts in an interpolated image between the first image and the second image. The apparatus also includes means for modifying an image configured to modify the interpolated image based on the determination.

These and other implementations consistent with the invention are further described below with reference to the following figures.

### BRIEF DESCRIPTION OF THE DRAWINGS

FIG. 1 illustrates a functional block diagram of an exemplary video encoding and decoding system.

FIG. 2 illustrates a functional block diagram of an example of a temporal luminance variation (TLV) detection and correction apparatus including a two-level hierarchical FRC.

FIG. 3 illustrates a functional block diagram of an example of a TLV detector.

FIG. 4 illustrates a functional block diagram of an example of an edge extractor.

FIG. 5 illustrates a functional block diagram of an example of a block-based characteristic extractor.

FIG. 6 illustrates a functional block diagram of an example of an image-based TLV detector.

FIG. 7 illustrates a functional block diagram of an example of a block-based local-global detector for image-based decision.

FIG. 8 shows a functional block diagram of an example of a motion vector deviation calculator.

FIG. 9 illustrates a functional block diagram of an example of a local-global TLV detector.

FIG. 10 illustrates a functional block diagram of an example of a TLV correction circuit.

FIG. 11 illustrates a process flow diagram for an example of a method of correcting temporal luminance variation artifacts during frame rate conversion.

FIG. 12 illustrates a functional block diagram of an example apparatus for correcting the temporal luminance variation (TLV) artifacts in an interpolated image between a first image and a second image.

In the figures, to the extent possible, elements having the same or similar functions have the same designations. Furthermore in accordance with mathematical notation conventions, in the figures and/or description below bold typeface or arrow notation (e.g. ii) may be used to indicate vectors.

### DETAILED DESCRIPTION

Detecting and correcting visual artifacts in image data can be a resource intensive process. In a frame rate conversion device including multiple hierarchical levels, various information elements may be generated which can be used to identify and correct visual artifacts. One example of an artifact that may be detected and corrected is temporal luminance variation. By leveraging information generated as part of the frame control process, local (e.g., pixel or block level) TLV and global (e.g., whole image) TLV may be detected and corrected more efficiently than in systems where the detection and correction are not provided the information from the frame rate conversion. Described herein are several characteristics which are generated based on information from frame rate conversion which may be used to indicate if TLV is present, where TLV may be located, and how the TLV may be corrected.

In the following description, specific details are given to provide a thorough understanding of the examples. However, it will be understood by one of ordinary skill in the art that the examples may be practiced without these specific details. For example, electrical components/devices may be shown in block diagrams in order not to obscure the examples in unnecessary detail. In other instances, such components, other structures and techniques may be shown in detail to further explain the examples.

It is also noted that the examples may be described as a process, which is depicted as a flowchart, a flow diagram, a finite state diagram, a structure diagram, or a block diagram. Although a flowchart may describe the operations as a sequential process, many of the operations can be performed in parallel, or concurrently, and the process can be repeated. In addition, the order of the operations may be re-arranged. A process is terminated when its operations are completed. A process may correspond to a method, a function, a procedure, a subroutine, a subprogram, etc. When a process corresponds to a software function, its termination corresponds to a return of the function to the calling function or the main function.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Various aspects of embodiments within the scope of the appended claims are described below. It should be apparent that the aspects described herein may be embodied in a wide variety of forms and that any specific structure and/or function described herein is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

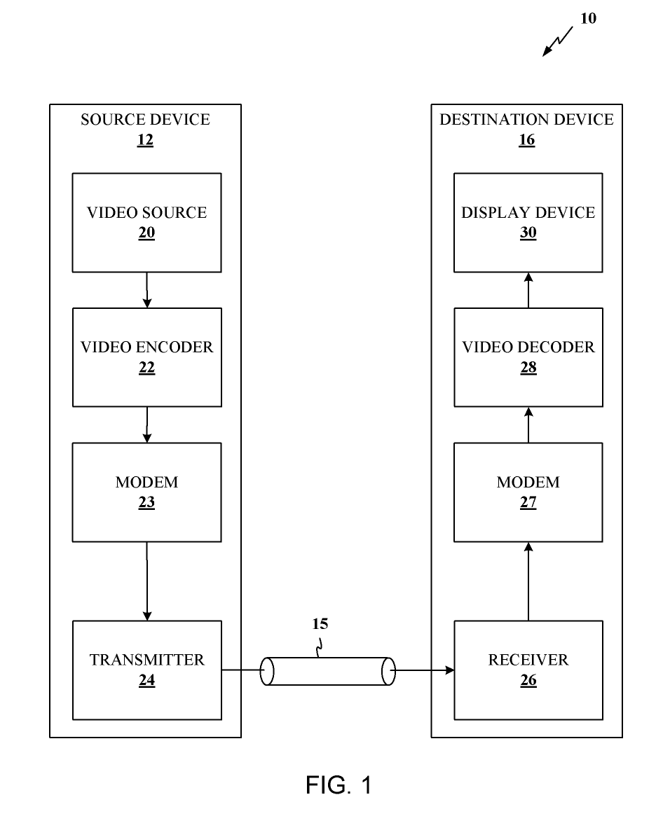

FIG. 1 illustrates a functional block diagram of an exemplary video encoding and decoding system. As shown in FIG. 1, system 10 includes a source device 12 that may be configured to transmit encoded video to a destination device 16 via a communication channel 15. Source device 12 and destination device 16 may comprise any of a wide range of devices, including mobile devices or generally fixed devices. In some cases, source device 12 and destination device 16 comprise wireless communication devices, such as wireless handsets, so-called cellular or satellite radiotelephones, personal digital assistants (PDAs), mobile media players, or any devices that can communicate video information over a communication channel 15, which may or may not be wireless. However, the techniques of this disclosure, which concern the detection and correction of temporal luminance variation from reference images or video, may be used in many different systems and settings. FIG. 1 is merely one example of such a system.

In the example of FIG. 1, source device 12 may include a video source 20, video encoder 22, a modulator/demodulator (modem) 23 and a transmitter 24. Destination device 16 may include a receiver 26, a modem 27, a video decoder 28, and a display device 30. In accordance with this disclosure, video encoder 22 of source device 12 may be configured to encode a sequence of frames of a reference image. The video encoder 22 may be configured to encode additional information associated with the images such as 3D conversion information including a set of parameters that can be applied to each of the video frames of the reference sequence to generate 3D video data. Modem 23 and transmitter 24 may modulate and transmit wireless signals to destination device 16. In this way, source device 12 communicates the encoded reference sequence along with any additional associated information to destination device 16.

Receiver 26 and modem 27 receive and demodulate wireless signals received from source device 12. Accordingly, video decoder 28 may receive the sequence of frames of the reference image. The video decoder 28 may also receive the additional information which can be used for decoding the reference sequence.

Source device 12 and destination device 16 are merely examples of such coding devices in which source device 12 generates coded video data for transmission to destination device 16. In some cases, devices 12, 16 may operate in a substantially symmetrical manner such that, each of devices 12, 16 includes video encoding and decoding components. Hence, system 10 may support one-way or two-way video transmission between video devices 12, 16, e.g., for video streaming, video playback, video broadcasting, or video telephony.

Video source 20 of source device 12 may include a video capture device, such as a video camera, a video archive containing previously captured video, or a video feed from a video content provider. As a further alternative, video source 20 may generate computer graphics-based data as the source video, or a combination of live video, archived video, and computer-generated video. In some cases, if video source 20 is a video camera, source device 12 and destination device 16 may form so-called camera phones or video phones. In each case, the captured, pre-captured or computer-generated video may be encoded by video encoder 22. As part of the encoding process, the video encoder 22 may be configured to implement one or more of the methods described herein, such as temporal luminance detection and/or correction for hierarchical frame rate conversion. The encoded video information may then be modulated by modem 23 according to a communication standard, e.g., such as code division multiple access (CDMA) or another communication standard, and transmitted to destination device 16 via transmitter 24. Modem 23 may include various mixers, filters, amplifiers or other components designed for signal modulation. Transmitter 24 may include circuits designed for transmitting data, including amplifiers, filters, and one or more antennas.

Receiver 26 of destination device 16 may be configured to receive information over channel 15. Modem 27 may be configured to demodulate the information. Again, the video encoding process may implement one or more of the techniques described herein such as temporal luminance detection and/or correction for hierarchical frame rate conversion. The information communicated over channel 15 may include information defined by video encoder 22, which may be used by video decoder 28 consistent with this disclosure. Display device 30 displays the decoded video data to a user, and may comprise any of a variety of display devices such as a cathode ray tube, a liquid crystal display (LCD), a plasma display, an organic light emitting diode (OLED) display, or another type of display device.

In the example of FIG. 1, communication channel 15 may comprise any wireless or wired communication medium, such as a radio frequency (RF) spectrum or one or more physical transmission lines, or any combination of wireless and wired media. Accordingly, modem 23 and transmitter 24 may support many possible wireless protocols, wired protocols or wired and wireless protocols. Communication channel 15 may form part of a packet-based network, such as a local area network (LAN), a wide-area network (WAN), or a global network, such as the Internet, comprising an interconnection of one or more networks. Communication channel 15 generally represents any suitable communication medium, or collection of different communication media, for transmitting video data from source device 12 to destination device 16. Communication channel 15 may include routers, switches, base stations, or any other equipment that may be useful to facilitate communication from source device 12 to destination device 16. The techniques of this disclosure do not necessarily require communication of encoded data from one device to another, and may apply to encoding scenarios without the reciprocal decoding. Also, aspects of this disclosure may apply to decoding scenarios without the reciprocal encoding.

Video encoder 22 and video decoder 28 may operate consistent with a video compression standard, such as the ITU-T H.264 standard, alternatively described as MPEG-4, Part 10, and Advanced Video Coding (AVC). The techniques of this disclosure, however, are not limited to any particular coding standard or extensions thereof. Although not shown in FIG. 1, in some aspects, video encoder 22 and video decoder 28 may each be integrated with an audio encoder and decoder, and may include appropriate MUX-DEMUX units, or other hardware and software, to handle encoding of both audio and video in a common data stream or separate data streams. If applicable, MUX-DEMUX units may conform to a multiplexer protocol (e.g., ITU H.223) or other protocols such as the user datagram protocol (UDP).

Video encoder 22 and video decoder 28 each may be implemented as one or more microprocessors, digital signal processors (DSPs), application specific integrated circuits (ASICs), field programmable gate arrays (FPGAs), discrete logic circuitry, software executing on a microprocessor or other platform, hardware, firmware or any combinations thereof. Each of video encoder 22 and video decoder 28 may be included in one or more encoders or decoders, either of which may be integrated as part of a combined encoder/decoder (CODEC) in a respective mobile device, subscriber device, broadcast device, server, or the like.

A video sequence typically includes a series of video frames. Video encoder 22 and video decoder 28 may operate on video blocks within individual video frames in order to encode and decode the video data. The video blocks may have fixed or varying sizes, and may differ in size according to a specified coding standard. Each video frame may include a series of slices or other independently decodable units. Each slice may include a series of macroblocks, which may be arranged into sub-blocks. As an example, the ITU-T H.264 standard supports intra prediction in various block sizes, such as 16 by 16, 8 by 8, or 4 by 4 for luma components, and 8 by 8 for chroma components, as well as inter prediction in various block sizes, such as 16 by 16, 16 by 8, 8 by 16, 8 by 8, 8 by 4, 4 by 8 and 4 by 4 for luma components and corresponding scaled sizes for chroma components. Video blocks may comprise blocks of pixel data, or blocks of transformation coefficients, e.g., following a transformation process such as discrete cosine transform or a conceptually similar transformation process.

Macroblocks or other video blocks may be grouped into decodable units such as slices, frames or other independent units. Each slice may be an independently decodable unit of a video frame. Alternatively, frames themselves may be decodable units, or other portions of a frame may be defined as decodable units. In this disclosure, the term “coded unit” refers to any independently decodable unit of a video frame such as an entire frame, a slice of a frame, a group of pictures (GOPs), or another independently decodable unit defined according to the coding techniques used.

In some implementations, motion estimation (ME) may be included as part of the video processing. For example, motion estimation may be achieved as described in U.S. patent application Ser. No. 12/338,960 entitled “Motion Estimation with an Adaptive Search Range,” which is herein incorporated by reference in its entirety. Estimating the motion vector (MV) may be based on block matching techniques, which divides an existing image into many blocks and then estimates for each block its own displacement on the second existing image. Some implementations include a block matching technique which based at least in part on the metric Sum of the Absolute Differences (SAD) between the given block in one image and a displaced block in the other image. ME may be performed by selecting the displacement giving the minimum SAD.

As an example, the forward estimated motion vector (MEF) can indicate the displacement of a given block in an image (Iₙ₋₁) with respect to a matched block in a subsequent image (Iₙ). The forward ME may generate a minimized sum of absolute differences errors (SADF) for the full search estimated MEF. Similarly, the backward estimated motion vector (MEB) can indicate the displacement of a given block in the image Iₙ with respect to a matched block in the image (Iₙ₋₁). MEB can also minimize the sum of absolute error SADB. Mathematically, SADF, SADB, and their forward and backward MVs (FMV and BMV respectively) can be defined as follows:

$$\begin{matrix}S A D F ( \vec{u} ) = {min}_{\vec{k}} \frac{1}{n ( \vec{R} )} {\sum }_{y ∈ \vec{R}}^{ } \vert {I}_{n - 1} ( \vec{u} W + \vec{y} ) - {I}_{n} ( \vec{u} W + \vec{y} + \vec{k} ) \vert & ( 1 ) \\ S A D B ( \vec{u} ) = {min}_{\vec{k}} \frac{1}{n ( \vec{R} )} {\sum }_{y ∈ \vec{R}}^{ } \vert {I}_{n - 1} ( \vec{u} W + \vec{y} ) - {I}_{n} ( \vec{u} W + \vec{y} + \vec{k} ) \vert & ( 2 ) \\ M E F ( \vec{u} ) = \vec{k} * minimizing S A D F in a given search zone & ( 3 ) \\ M E B ( \vec{u} ) = \vec{k} * minimizing S A D B in a given search zone . & ( 4 )\end{matrix}$$

In Equations (1)(4), \vec{R} denotes the current window region, n(\vec{R}) is the region size, \vec{y} are the coordinates of pixels within the window \vec{R}, and \vec{k} is a displacement in a given search zone. The SADF(\vec{u}), the SADB(\vec{u}), and the corresponding MVs can be associated to a small window \vec{W} centralized inside the reference region \vec{R}. In some implementations, the window \vec{W} size is W×W=8×8. The variable \vec{u} represents the coordinates of the current block W; \vec{u}=Integer[\vec{x}/W] for a pixel of coordinates Ft in the current block.

Some implementations may also include a zero motion estimation errors (SAD0(\vec{u})) which may be determined based upon the following normalized sum of the absolute difference between two images:

$$S A D 0 ( \vec{u} ) = \frac{1}{n ( \vec{R} )} {\sum }_{y ∈ \vec{R}}^{ } \vert {I}_{n - 1} ( \vec{u} W + \vec{y} ) - {I}_{n} ( \vec{u} W + \vec{y} + \vec{k} ) \vert \qquad ( 5 )$$

The processing of supposedly still pictures may be based at least in part on the metric SAD0.

In the above related references, the MV can be estimated more precisely at pixel resolution instead of block based resolution. However, similar to the Equations (1), (2) or (5), the estimate may be based on the absolute difference between the two respective intensities of the past image Lₙ₋₁ and the present image Iₙ.

The ME techniques based on the absolute difference work well for some images. In the case where the displacement model for an image is no longer valid, the ME may be hindered by occlusion or temporal luminance variation (TLV) between two images. Systems and methods to address the occlusion aspect and its associated halo effects may be included with the systems and methods described herein.

The TLV between the two images can have multiple causes. For example, live arena or stadium events, like a hockey game or concert, can be rapidly illuminated by various individual camera flashes from spectators. Another example, when an object is moving under a tree, the light on the object can be changed partly or totally in function of the leaves' shadow. Sunrise and sunset scenes captured with long camera exposure are also examples of local or global temporal luminance transitions. Moreover, these local variations can create spurious contours at their borders.

One method of preventing the variation lighting conditions, for a temporal DPCM compression, includes equalizing the mean intensity value of the blocks in ME equations. However, when the lighting is normal or not temporally varying, both mean intensity and high frequency components of a block may be two influential factors in ME. In such implementations, removing the mean intensity implies the ME is based only on high frequency or edge information. Furthermore, the mean intensity calculation on various blocks can introduce additional cost (e.g., computation, time, processor) to perform the motion estimation. Additionally, some implementations perform temporal prediction error in a DPCM can be received via coded and transmitted information which is re-introduced in feedback rather than incorporated into the processing stream such as frame rate control. In a FRC the situation, a temporal ME error will result directly visible artifacts in the output pictures.

Some implementations consider a specific case of varying luminance of a frame-wide change occurring to the pixels. Such a frame-wide change may include a scene change or a fade-in fade-out of two different scenes stitched together temporally. The detection method may be based on the histogram of the inter frame difference and the correction is a frame-wide mixing between the results of MC interpolation and temporal interpolation or even frame repetition. The mixing level may then be a function of the detected reliability provided from the image difference histogram.

In the case of frame-wide change, the histogram of the image difference may generally be well-defined including a dominating peak. However, in the general case of temporal luminance variation, the previous and present scenes can be very similar except for some local changes. The suggested method of image difference histogram may be inadequate to detect such fine variations within a frame. Moreover, regarding the correction, if the luminance variation is constrained in some small locations, the frame-wide mixing can result in visible motion judder in the whole image when MV are large and inversely, when MV is small, some eventual blurs in the resulted image.

Some implementations may include hierarchical frame rate conversion for use in, for example, high-resolution television. Such approaches may address temporal luminance variation by using two existing images and a temporary interpolated image. However, the temporary interpolated image may not be adapted for improved of temporal luminance variation detection.

In an image interpolation, the exhaustive ME can consume a high number of operations and calculations when operating directly on the original resolution images such as ultra definition UD or high definition HD images. Such image processors may not have sufficient bandwidth or capacity to fully implement the operation. To reduce the complexity, various ME techniques may be included in a video encoding or decoding device. Once such technique is a hierarchical approach which may be used not only for high definition images, but is also suited for use with low or medium resolution image formats such as QCIF, CIF, or Standard definition SDTV.

The hierarchical process may include a tree decomposition of an original image into many resolution level sub-images. The original resolution image or first level image after a first filtering and decimation may yield a lower resolution sub image determining the 2^{nd} level image. The filtering and decomposition process continues for the obtained sub-image to provide a 3^{rd} level sub-image, and so on in the pyramidal hierarchical decomposition.

Without loss of any generality, the original input images may be considered HDTV images.

In some embodiments, a method of detecting temporal luminance variation between a first image and a second image includes reducing the first image and the second image to form a first lower resolution image and a second lower resolution image; extracting new edges from the first lower resolution image and still edges from a frame delay of detected edges image; extracting TLV characteristics based on the block-based intensities and the block-based zero-motion estimation error; synthesizing the block-based TLV characteristics and the detected edges to form a global detection of temporal luminance variation possibility in an image; detecting local and global corrections in an image from block-based motion vectors, block-based motion estimation errors (SAD) and detected characteristic; detecting a flashing scene from an other detected characteristic; delaying the image-based decision to timely match to the current image; localizing TLV artifacts from the pixel-based intensities of the first lower resolution image and the second lower resolution image, the pixel-based motion estimation weighted errors, the pixel-based motion vectors and the delayed image-based decisions; correcting local artifacts by a non-linear temporal interpolation based on the located TLV and; correcting global artifacts by frame repeating based on the global correction decision or the detected flashing scene.

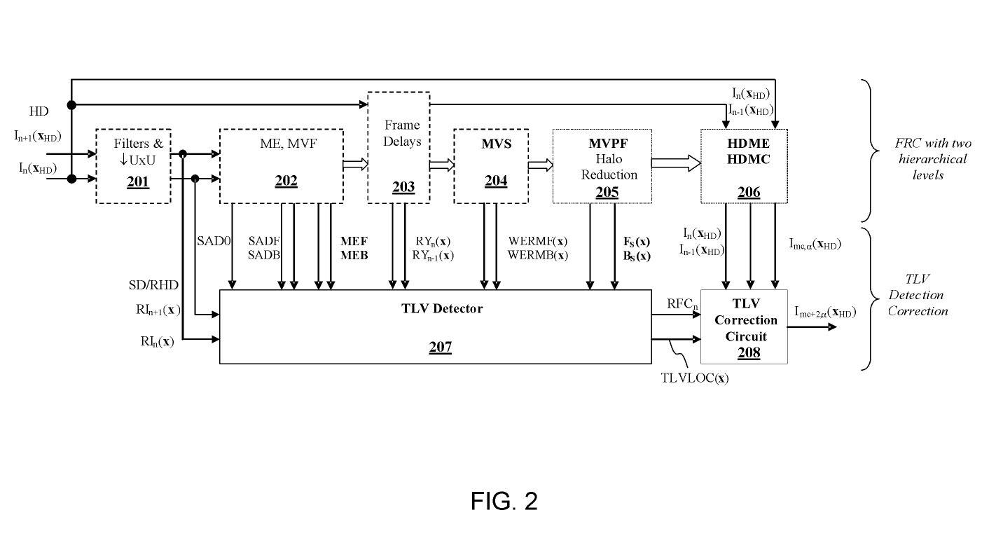

FIG. 2 illustrates a functional block diagram of temporal luminance variation (TLV) detection and correction apparatus including a two-level hierarchical FRC. FIG. 2 includes a frame rate converter (FRC) with two hierarchical levels for the original HDTV inputs and a TLV detection and correction unit. The apparatus shown may be included in, for example, the video encoder 22 or the video decoder 28 as shown in FIG. 1.

The FRC may include two dimensional filters and decimations 201, forward and backward motion estimators (ME) and motion vector filtering (MVF) 202, frame delays 203, motion vector selectors (MVS) 204, motion vector post filtering for halo reduction (MVPF) 205 and, high definition motion estimation (HDME) and motion compensated interpolation (HDMC) 206. The frame delays 203 may be included to divide as equitably as possible the timing required for ME and for HDMC operations.

In short, the filters and decimators U×U 201 provide, based on the image inputs Iₙ₊₁(\vec{x}_{HD}) and Iₙ(\vec{x}_{HD}), two corresponding reduced resolution images RIₙ₊₁(\vec{x}) and RIₙ(\vec{x}) which are provided to a TLV detector 207. RIₙ₊₁ and RIₙ denote respectively the future and the present reduced images. Moreover, if the notation \vec{x}_{HD} represents the current pixel coordinates (column, row) in the high resolution image, then \vec{x} is the pixel coordinates in the reduced resolution image. The relation between \vec{x} and \vec{x}_{HD} is given by \vec{x}=Integer[\vec{x}_{HD}/U]=[\vec{x}_{HD}/U]. The ME and MVF 202 provides block-based information such as SAD0(\vec{u}), forward and backward MV MEF(\vec{u}), MEB(\vec{u}) and their associated difference metrics SADF(\vec{u}), SADB(\vec{u}). For simplicity, the current block coordinates notation \vec{u} can be sometimes omitted in this disclosure if there is no ambiguity. The frame delays 203 may provide two reduced resolution images RIₙ(\vec{x}) and RIₙ₋₁(\vec{x}) respectively for the present and the past reduced images. The motion vector selector (MVS) 204 may generate the pixel-based motion vector estimations WERMF(\vec{x}) and WERMB(\vec{x}). The halo reduction MVPF 205 provide may be configured to the pixel-based forward and backward motion vectors Fₛ(\vec{x}) and Bₛ(\vec{x}) between the images RIₙ(\vec{x}) and RIₙ₋₁(\vec{x}) of reduced resolution. The HDME and HDMC 106 may be configured to generate an originally high resolution motion compensated image I_{mc,α}(\vec{x}_{HD}) in which the subscript alpha, α, denotes the relative distance of the interpolated image I_{mc,α}\vec{x}_{HD}) in respect to the position of the present image Iₙ(\vec{x}_{HD}). Alpha equal to 1 may correspond to the past image Iₙ₋₁(\vec{x}_{HD}) position. The interpolated image I_{mc,α}(\vec{x}_{HD}) may be provided to the TLV correction circuit 208.

As illustrated by FIG. 2, the local and global TLV detector 207 obtains the cited signals as inputs and may generate the global repeat frame correction (RFCₙ) and the pixel based TLV local correction (TLVLOCₙ(\vec{x})). The TLV correction circuit 208 may obtain the RFCₙ+TLVLOCₙ(\vec{x}), convert them to the original (HD) resolution, and modify the image by appropriately combining the three images Iₙ(\vec{x}_{HD}), Iₙ₋₁(\vec{x}_{HD) and I}_{mc,α}(\vec{x}_{HD}) to provide finally I_{mc+2,α}(\vec{x}_{HD}) at the interpolation position alpha, α.

The detection of temporal luminance variation occurring between two consecutive input images can be based on one or more of the following characteristics: (a) the local mean intensity value in a flat region can change, (b) the block-based local motion estimation errors SAD, as well as the zero motion estimation error SAD0, may become higher in a large part of the picture, (c) the pixel based motion estimation errors WERMF, WERMB also may be higher in a large part of the picture, (d) the MV field may become no more smooth but contains erratic or irregular variations, and (e) at least for the pixel-based case, the motion vector lengths can become big in regions of temporal luminance variation.

Another characteristic which may be considered during TLV detection is the contour in the images. Even for a slowly moving or still picture, the number of the contour pixel in the present image can exceed notably the number of the still contour pixels when in presence of TLV. However, to differentiate the moving picture and the TLV effect, the number of the present image contour pixels should be limited to some factor of the still contour number. Beyond that limit, the case of normal moving pictures may be assumed and it can be handled by the FRC. This consideration may be useful for reducing false detections.

The following table summarizes the detection parameters considered in some implementations.

TABLE 1
Detection Parameters and Characteristics

| | |
|---|---|
| (a) | Local mean intensity value in flat region can change |
| (b) | Block-based motion estimation error SAD, SAD0 become higher in a |
| | large part of picture. |
| (c) | Pixel-based motion estimation error WERMF, WERMB are higher in |
| | a large part of picture. |
| (d) | Motion Vector Field contains bizarre or weird variations |
| (e) | Motion Vector Lengths can become big in some zone of temporal |
| | luminance variation |
| (f) | Contour pixel numbers are useful for false detection reduction. |

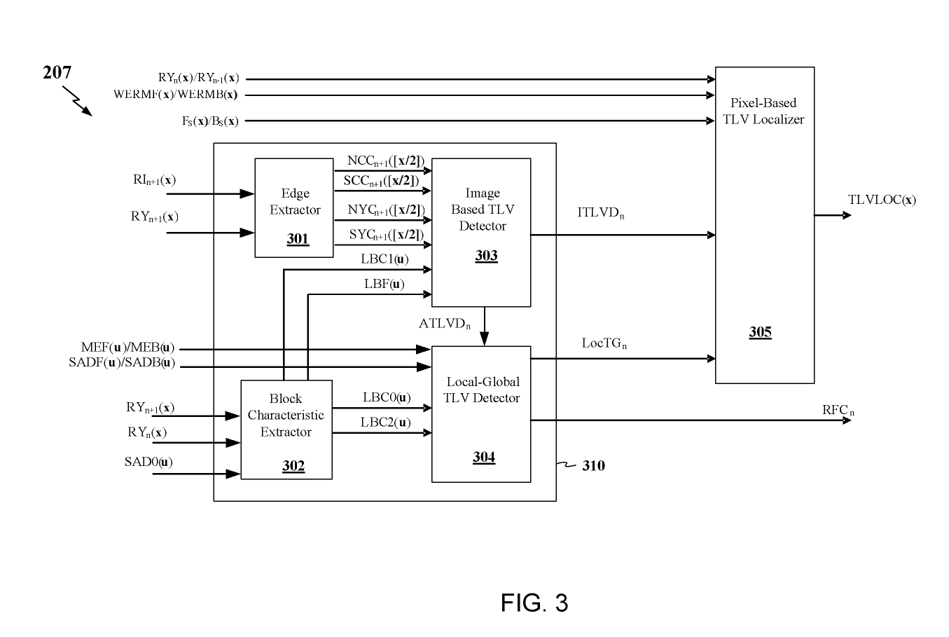

FIG. 3 illustrates a functional block diagram of an example of a TLV detector. The TLV detector 207 may be configured to detect TLV artifacts for images of reduced resolution. The TLV detector 207 shown in includes two parts: a first part configured to perform block-based analysis; and a second part configured to perform pixel-based analysis.

A block-based analyzer 310 may include an edge extractor 301, a block characteristic extractor 302, an image based TLV detector 303, and a local global detector 304. The block-based analyzer 310 may be configured to provide a frame-based global detection where TLV occurs between the two consecutive input images. In some implementations, if global TLV is detected, the TLV may affect the whole (interpolated) frame or only some parts of the interpolated frame. The pixel-based analyzer 305 may be configured to determine the locations of TLV artifacts in a picture.

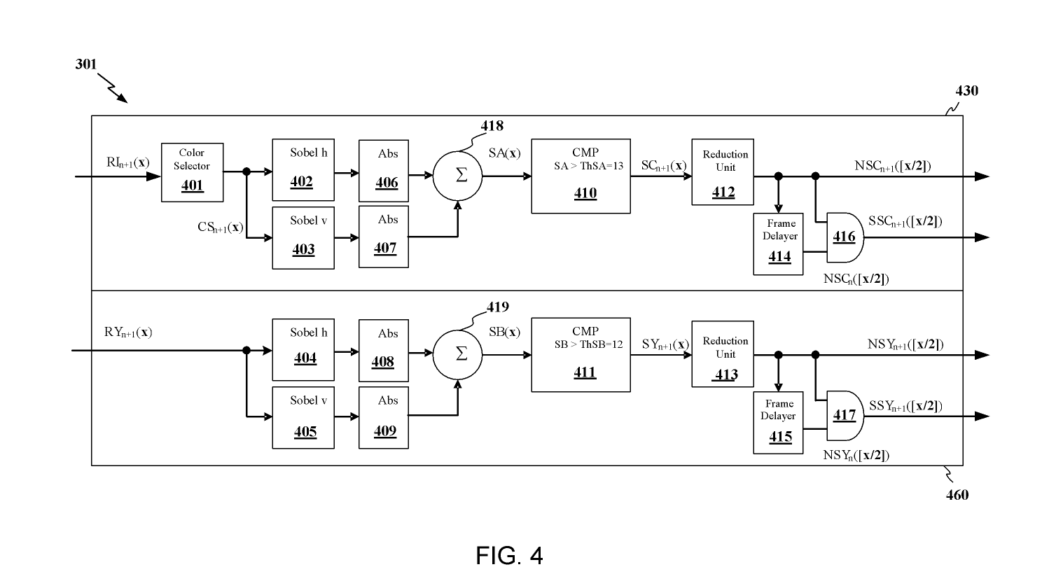

The reduced resolution color images RIₙ₊₁(\vec{x}) and the monochrome luminance RYₙ₊₁(\vec{x}) may be provided as inputs to the edge extractor 301. The color image RIₙ₊₁(\vec{x}) may include values indicating the three standard colors (R, G, B). The processing of color animated clips may be based at least in part on the color image. Combining both color image RIₙ₊₁(\vec{x}) and luminance image RYₙ₊₁(\vec{x}) can provide a robust contour detection. The edge extractor 301 outputs are NCCₙ₊₁([\vec{x}/2]), SCCₙ₊₁([\vec{x}/2]), NYC-ₙ₊₁([\vec{x}/2]), SYCₙ₊₁([\vec{x}/2]), respectively for new color contour, still color contour, new luminance contour, and still luminance contour. As used herein, the subscript n+1 indicates the future frame timing n+1. The variable argument [x/2] after a 2×2 grouping and down sampling will be explained later in the description of FIG. 4. The above four edge extractor 301 outputs may be provided to the image based TLV detector 303.

The reduced resolution luminance future image RYₙ₊₁(\vec{x}) the previous version of the image RYₙ(\vec{x}), and the zero-motion estimation error SAD0(\vec{u}) may be provided as inputs to the block characteristic extractor 302. The block characteristic extractor 302 may be a block-based characteristic extractor. In some implementations, the block characteristic extractor 302 may be configured to extract more than one characteristic. The block characteristic extractor 302 shown in FIG. 3 is configured to provide four TLV characteristics LBC0(\vec{u}) LBC1(\vec{u}), LBC2(\vec{u}) and LBF(\vec{u}) where LBF represents a local block-based flat zones detected in the inter-image difference, and LBC denotes a local block-based TLV characteristic. As shown, the characteristics are provided to the image based TLV detector 303 and the local global detector 304. In some implementations, the block characteristic extractor 302 may be configured to provide the characteristics to other elements such as the TLV localizer 305.

The image-based TLV detector 303 may be configured to determine whether the whole image includes TLV artifacts. The determination (ITLVDₙ) may be based at least in part on information provided by the edge extractor 301. For example, as shown in FIG. 3, NCCₙ₊₁([\vec{x}/2]), SCCₙ₊₁([\vec{x}/2]), NYCₙ₊₁([\vec{x}/2]), and SYCₙ₊₁([\vec{x}/2]) are provided to the image based TLV detector 303.

The image based TLV detector 303 may be configured to base the determination on information received from the block characteristic extractor 302. As shown in FIG. 3, two block-based characteristics maps LBC1(\vec{u}) and LBF(\vec{u}) are provided to the image based TLV detector 303.

The image-based determination generated by the image-based TLV detector 303 may be provided as an enable signal. This signal may be provided to the pixel-based TLV localizer 305. The image-based TLV detector 303 may also be configured to provide an absolute size TLV detection signal (ATLVD,ₙ). As shown in FIG. 3, the absolute size TLV detection signal may be provided to the local global detector 304.

The local-global TLV detector 304 may be configured to assess the TLV for the present image as well as the TLV relative to the previous image. As shown in FIG. 3, local-global TLV detector 304 may provide two output signals, RFCₙ indicating global TLV artifacts affecting the whole image. This indication may be used to signify that repeat frame correction may be suitable for the image. The second output signal, LocTGₙ, indicates whether, between the present and the previous images, the TLV artifacts are local or if the TLV artifacts are global.

The local-global TLV detector 304 may be configured to generate the output signals based at least in part on the block characteristic map LBC0(\vec{u}), LBC2(\vec{u}) provided by the block characteristic extractor 302. The local-global TLV detector 304 may be configured to generate the output signals based at least in part on the block-based forward and backward motion vector estimations MEF(\vec{u}) and MEB(\vec{u}) as well as the associated forward and backward motion estimation errors SADF(\vec{u}) SADB(\vec{u}) provided by the motion estimator and vector filter (ME, MVF) 202. As discussed above, the local-global TLV detector 304 may also base the determination on the ATLVDₙ signal provided by the image based TLV detector 303. In some implementations, using LocTG and ITLVD may be provided to for pixel-based TLV analysis. As discussed, by detecting TLV at the pixel level, the number of false TLV detections may be reduced as compared with whole image or block-based TLV detection.

Accordingly, as shown in FIG. 3, ITLVDₙ and LocTGₙ may be provided to the pixel-based TLV localizer 305. The pixel-based TLV localizer 305 may also obtain other pixel-based information such as images RYₙ(\vec{x}), RYₙ₋₁(\vec{x}), forward backward motion vectors Fₛ(\vec{x}), Bₛ(\vec{x}) as well as their associative ME errors WERMF(X) and WERMB(X). Based on this information, the pixel-based TLV localizer 305 may locate where the TLV artifacts and generate a binary indication map TVLLOC(\vec{x}) including the location information. The TLVLOC(\vec{x}) map may be provided to the TLV correction circuit 208 for final local TLV correction.

FIG. 4 illustrates a functional block diagram of an example of an edge extractor. The edge extractor 301 may be configured to detect edges based on obtained inputs. As shown in FIG. 4, the inputs may include the luminance image RYₙ₊₁(\vec{x}) and the color image RIₙ₊₁(\vec{x}), which includes values indicating the three standard colors (R, G, B). As illustrated in FIG. 3, the edge extractor 301 can include multiple branches for edge extraction. As shown, the edge extractor 301 includes a chrominance based edge extractor 430 and a luminance based edge extractor 460.

The chrominance based edge extractor 430 may include a color selector 401. The color selector 401 may be configured to combine the three color images (R, G, and B) in one monochrome image CS(\vec{x}). The color selector 401 may have several possible solutions depending on subsequent algorithms. In some implementations, the color selector 401 may be configured to select colors based on 8-bit video. In such implementations, the color selector 401 may be configured to determine the monochrome image CS(\vec{x}) based at least in part on Equation 6.

$$CS ( x ) = \{ \begin{matrix}\begin{matrix}max ( R ( \vec{x} ) , G ( \vec{x} ) , B ( \vec{x} ) , 238 - \\ min ( R ( \vec{x} ) , G ( \vec{x} ) , B ( \vec{x} ) ) )\end{matrix} & \begin{matrix}\begin{matrix}if ( R ( \vec{x} ) > Th ) or ( R ( \vec{x} ) < T l ) \\ or ( G ( \vec{x} ) > Th ) or ( G ( \vec{x} ) < Tl )\end{matrix} \\ or ( B ( \vec{x} ) > Th ) or ( B ( \vec{x} ) < Tl )\end{matrix} \\ min ( R ( \vec{x} ) , G ( \vec{x} ) , B ( \vec{x} ) ) & otherwise\end{matrix} \qquad ( 6 )$$

where Th and Tl are configurable high and low threshold values.

In some implementations, the color selector 401 may be configured to determine the monochrome image CS(\vec{x}) based at least in part on Equation 7.

CS(\vec{x})=max(R(\vec{x}), G(\vec{x}), B(\vec{x}), Y(\vec{x})) (7)

The selected image signal CSₙ₊₁(\vec{x}) for the input image frame (n+1) may be provided to one or more Sobel contour extractors. As shown in FIG. 4, the chrominance based edge extractor 430 includes two Sobel contour extractors, a chrominance horizontal Sobel contour extractor 402 and a chrominance vertical Sobel contour extractor 403.

The luminance based edge extractor 460 may also include one or more Sobel contour extractors. As shown in FIG. 4, the luminance based edge extractor 460 includes two Sobel contour extractors, a luminance horizontal Sobel extractor 404 and a vertical luminance Sobel extractor 405. The luminance horizontal Sobel extractor 404 and the vertical luminance Sobel extractor 405 may be configured to obtain the luminance image signal RYₙ₊₁(\vec{x}) for contour extraction.

In some implementations, the contour extraction process may be similar for the two signals CSₙ₊₁(\vec{x}) and RYₙ₊₁(\vec{x}). The Sobel contour extractors may be included to reduce the effect of noise in the image on the edge detection. It will be appreciated that other methods of noise reduction may be included without departing from the scope of the disclosure. The horizontal and vertical Sobel contour extractors may reduce the noise based at least in part on Sobel horizontal and vertical masks given respectively as:

$${Sobel}_{h} = [ \begin{matrix}- 1 & 0 & 1 \\ - 2 & 0 & 2 \\ - 1 & 0 & 1\end{matrix} ] / 8 , {Sobel}_{v} = [ \begin{matrix}1 & 2 & 1 \\ 0 & 0 & 0 \\ - 1 & - 2 & - 1\end{matrix} ] / 8 \qquad ( 8 )$$

The output of each Sobel extractor 402, 403, 404, and 405 may be provided to the absolute value circuits 406, 407, 408, and 409 respectively. The results may be provided to adder units 418 and 419, respectively. The value produced by the adder units 418 and 419 indicate a Sobel contour strengths SA(\vec{x}) and SB(\vec{x}) for the chrominance and luminance images, respectively. A pixel\vec{x} is detected as contour if its local contour strength SA(\vec{x}) is bigger than some threshold. The decision device is the comparator 410. For color selected image CSₙ₊₁(\vec{x}), the detected contour map is denoted as SCₙ₊₁(\vec{x}).

The chrominance based edge extractor 430 may include a comparator 410. The comparator 410 may be configured to obtain the detected contour strengths SA(\vec{x}). The comparator 410 may then compare the strength of each pixel \vec{x} with a threshold value (ThSA). As shown in FIG. 4, the value of 13 is used. In some implementations, ThSA may be 3, 20, or 2.1. As shown, if the SA value for pixel \vec{x} is greater than the threshold ThSA, the pixel \vec{x} may be identified as a contour. In some implementations, a second threshold may be included to provide a range for pixel values that may be identified as a contour. In such implementations, a pixel \vec{x} may be identified as a contour if the strength value falls within the specified contour strength threshold range.

The comparator 410 may provide the pixel identification information via a binary contour map SCₙ₊₁(\vec{x}). The binary contour map may be provided in the dimension of reduced images. In some implementations, the given dimension may be reduced. The chrominance based edge extractor 430 may include a reduction unit 412 to reduce the binary contour map. For example, the reduction unit 412 may be configured to down sample by a factor, such as 2×2. In some implementations, the reduction may increase processing efficiency. Since the contour map in FIG. 4 is binary, the reduction unit 412 may be configured to perform “or 2×2 and decimation 2×2” as shown in Equation 9.

$$Out ( [ \vec{x} \text{/} 2 ] ) = {⋃}_{p = 0}^{1} {⋃}_{q = 0}^{1} In ( [ c \text{/} 2 ] 2 + p , [ r \text{/} 2 ] 2 + q ) \qquad ( 9 )$$

where \vec{x}=(c, r) indicates the coordinate values of the current pixel.

The reduction unit 412 may generate an output NSCₙ₊₁([\vec{x}/2]) representing the reduced new Sobel contour map for the selected color image (n+1). To detect the still contour, the map NSCₙ([\vec{x}/2]) may be delayed one frame by frame delayer 414 which provides the delayed version output signal NSCₙ([\vec{x}/2]). The signal NSCₙ([\vec{x}/2]) may represent the Sobel contour map of the previous image. Combining the new contour map and the previous contour map via an AND gate 416 yields SSCₙ₊₁([\vec{x}/2]) representing the still contour map, pixel by pixel but in half resolution, in both image RCₙ₊₁(\vec{x}) and RCₙ(\vec{x}). According the edges detected in the new Sobel contour map represent images which are included in the current image (e.g., new edges). The edges identified in the still contour map represent edges included in the current image that were also included in the previous image (e.g., still edges).

Returning the luminance based edge extractor 460, the luminance based edge extractor 460 may also include a comparator 411. The comparator 411 be configured to obtain the detected contour strengths SB(\vec{x}). The comparator 411 may then compare the strength of each pixel x with a threshold value (ThSB). As shown in FIG. 4, the value of 12 is used. In some implementations, ThSB may be 4, 19, or 1.1. The thresholds ThSA and ThSB are generally different. However, in some implementations, ThSB may be the same as ThSA. Furthermore, one or both thresholds may be adaptive. For example, a threshold can be based on a color selection technique included in the system.

As shown, if the SB value for pixel \vec{x} is greater than the threshold ThSB, the pixel \vec{x} may be identified as a contour. In some implementations, a second threshold may be included to provide a range for pixel values that may be identified as a contour. In such implementations, a pixel \vec{x} may be identified as a contour if the strength value falls within the specified contour strength threshold range.

The comparator 411 may provide the pixel identification information via a binary contour map SYₙ₊₁(\vec{x}). The luminance based edge extractor 460 may include a reduction unit 413 which is similarly configured as reduction unit 412. For example, the reduction unit 413 may be configured to down sample by a factor, such as 2×2. Since the contour map in FIG. 4 is binary, the reduction unit 413 may be configured to perform “or 2×2 and decimation 2×2” as shown above in Equation 9.

The reduction unit 413 may generate two contour maps NSYₙ([\vec{x}/2]) and SSYₙ₊₁([\vec{x}/2]) for the new and the still contours of luminance images respectively. Similar to the chrominance based edge extractor 430, the luminance based edge extractor 460 may include a frame delayer 415. To detect the still contour, the map NSYₙ([\vec{x}/2]) may be delayed one frame by frame delayer 415 which provides the delayed version output signal NSYₙ([\vec{x}/2]). The signal NSYₙ([\vec{x}/2]) may represent the Sobel contour map of the previous image. Combining the new contour map and the previous contour map via an AND gate 417 yields SSYₙ₊₁([\vec{x}/2]) representing the still contour map, pixel by pixel but in half resolution, in both image RYₙ₊₁(\vec{x}) and image RYₙ(\vec{x}).

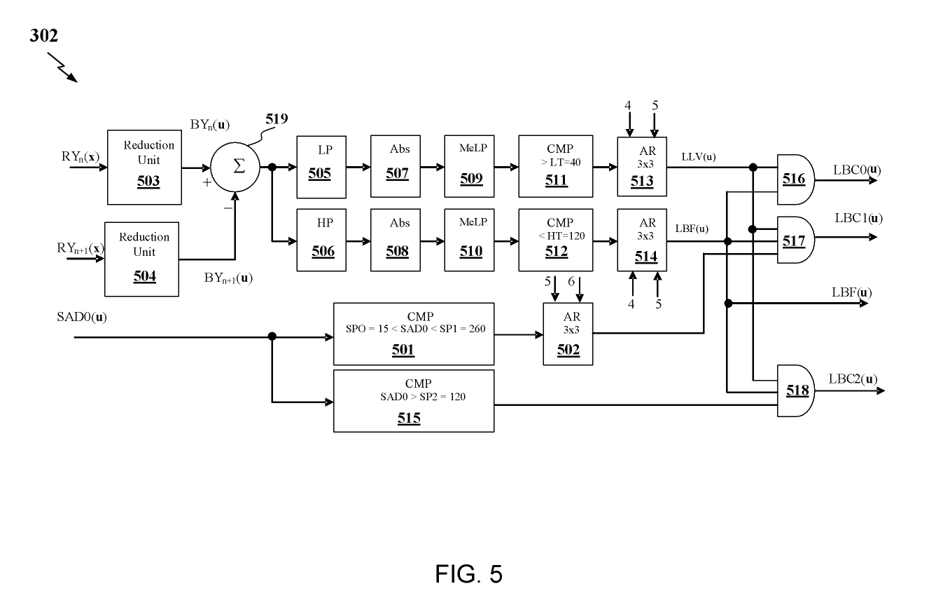

FIG. 5 illustrates a functional block diagram of an example of a block-based characteristic extractor. The block-based characteristic extractor 302 may be configured to extract characteristics based on a TLV or temporal gradient (TG) of luminance. The extraction process may be based on two parameters, namely the luminance input images RYₙ₊₁(\vec{x}), RYₙ(\vec{x}) and the zero-motion estimation error SAD0(\vec{u}). These parameters partially indicate the characteristics (a) and (b) in Table 1 above.

For block-based resolution, the block-based characteristic extractor 302 may include two reduction units, reduction unit 503 and reduction unit 504. The reduction unit 503 may be configured to filter and/or down sample the image RYₙ(\vec{x}). For example, the reduction unit 503 may be configured to filter and down sample the image based at least in part on the block size factor W×W where W is the block window dimensions. In some implementations, W may be 8. The reduction unit 504 may be similarly configured to filter and/or down sample the image RYₙ₊₁(\vec{x}). The respective outputs of reduction unit 503 and reduction unit 504 are denoted as BY (u)and BYₙ₊₁(\vec{u}). By this notation, BY designates block-based luminance.

The block-based characteristic extractor 302 may include an adder 519 configured to find the difference between the two image signals. The different may indicate a temporal luminance variation between the images. The block based characteristic extractor 302 may include additional filters to process the difference value. As shown in FIG. 5, a low-pass (LP) filter 505 and a high-pass (HP) filter 506 are included. The low-pass filter 505 may be configured to perform a 3×3 low-pass filtering of the input signal. The high-pass filter 506 may be configured to perform a complementary (e.g., 3×3) high-pass filtering of the input signal. The utilized LP and HP impulse responses may be respectively given by Equation 10.

$$LP = [ \begin{matrix}1 & 1 & 1 \\ 1 & 1 & 1 \\ 1 & 1 & 1\end{matrix} ] , \\ HP = [ \begin{matrix}- 1 & - 1 & - 1 \\ - 1 & + 8 & - 1 \\ - 1 & - 1 & - 1\end{matrix} ] \qquad ( 10 )$$

The low-pass filter 505 and high-pass filter 506 outputs may be provided to the absolute value circuits 507, 508, respectively. The value generated by absolute value circuit 507 may be provided to a mean low-pass (MeLP) filter 509. The value generated by the absolute value circuit 508 may be provided to a second mean low-pass filter 510. In some implementations, mean low-pass filter 509 and the second mean low-pass filter 510 may be configured to apply an impulse response as given, for example, by Equation 11.

$$MeLP = [ \begin{matrix}3 & 4 & 3 \\ 4 & 4 & 4 \\ 3 & 4 & 3\end{matrix} ] / 32 \qquad ( 11 )$$

In some implementations, this may help reduce compression artifacts such as the so-called Gibbs effect. It will be appreciated that other arrangements may be provided to achieve a similar result.

The mean low-pass filter 509 may be configured to generate an output representing the local mean luminance variation between two input images. This output may be provided to a comparator (CMP) 511. The comparator 511 may be configured to detect a local low frequency luminance variation. In the implementation shown, the comparator 511 may be configured to identify a local low frequency luminance variation based on the mean low-pass filter 509 output value as compared with a threshold value (LT). As shown in FIG. 5, the determination is based on whether the output value exceeds the threshold LT. In some implementations, two values may be used to provide a range of threshold tolerance. Furthermore, the threshold may be predetermined or adaptively generated (e.g., based on a characteristic of the image or device settings). As shown in FIG. 5, the threshold (LT) value is 40. In some implementations, LT may be 10, 60, or 102.2.

Similarly, the second mean low-pass filter 510 may be configured to generate an output representing the local mean high frequency luminance variation. This output value may be provided to a second comparator (CMP) 512. The second comparator 512 may be configured to detect a flat zone. The detection may be based at least in part on a comparison of the variation to a second threshold (HT). In the example shown in FIG. 5, if the variation value is less than the second threshold HT, a flat zone may be detected. As above, in some implementations, two values may be used to provide a range of threshold tolerance. Furthermore, the second threshold (HT) may be predetermined or adaptively generated (e.g., based on a characteristic of the image, or device settings). As shown in FIG. 5, the threshold (HT) value is 120. In some implementations, HT may be 110, 160, or 123.4.

The block-based characteristic extractor 302 may include a first add and remove (AR) context-based binary filter 513 and a second add and remove (AR) context-based binary filter 514. The first AR context-based binary filter 513 may be configured to consolidate the local low frequency luminance variation provided by the comparator 511. As shown in FIG. 5, the AR context-based binary filter 513 may be a 3×3 filter. The second AR context-based binary filter 514 may be configured to consolidate the flat zone detection provided by the second comparator 512. As shown in FIG. 5, the second AR context-based binary filter 514 may be a 3×3 filter.

The first AR context-based binary filter 513 and/or the second AR context-based binary filter 514 may be implemented in a variety of ways. In one implementation, a binary filter may be configured as an AR context-based filter if the filter output s(c,r) is written as:

$$s ( c , r ) = \{ \begin{matrix}1 , & if {\sum }_{i} {\sum }_{j} {in}_{ij} ( c , r ) \geq {Threshold}_{B} \\ 0 , & if {\sum }_{i} {\sum }_{j} {in}_{ij} ( c , r ) \leq {Threshold}_{S} \\ in ( c , . r ) , & otherwise\end{matrix} \qquad ( 12 )$$

In such implementations, the binary filter may be defined on a rectangular window centered at the coordinates (c,r) where inᵢⱼ(c,r) is the filter binary input of relative coordinates (i,j) inside the considered window.

Similarly, a binary filter is said be an add only filter if the Thresholdₛ=0 as, for example, in Equation 13.

$$s ( c , r ) = \{ \begin{matrix}1 , & if {\sum }_{i} {\sum }_{j} {in}_{ij} ( c , r ) \geq {Threshold}_{B} \\ in ( c , . r ) , & otherwise\end{matrix} \qquad ( 13 )$$

If the Threshold_{B} is not specified in the filter block diagram, it implies the threshold is equal to 1, a preset value.

Finally, a binary filter is said a remove only filter if the Threshold_{B} exceeds the window size, as for example, in Equation 14.

$$s ( c , r ) = \{ \begin{matrix}0 , & if {\sum }_{i} {\sum }_{j} {in}_{ij} ( c , r ) \leq {Threshold}_{s} \\ in ( c , . r ) , & otherwise\end{matrix} \qquad ( 14 )$$

The AR context-based binary filter 513 may be configured to generate an output signal LLV(\vec{u}) representing the consolidated block-based detected local mean temporal luminance variation map. The second AR context-based binary filter 514 may be configured to generate an output signal LBF(\vec{u}) corresponds meanwhile to the detected map of local block-based flat zone. The two signals LLV(\vec{u}) and LBF(\vec{u}) may be combined via an AND gate 516 to the first local block-based characteristic LBC0(\vec{u}). This signal represents a map of temporal variation zones of said “local mean intensity in flat region.” The LBC0(\vec{u}) characteristic signal may be provided to the local-global TLV detector 304 for local and/or global TLV decision.

As shown in FIG. 5, the block-based characteristic extractor 302 may also obtain the zero motion estimation error value SAD0(\vec{u}). The block-based characteristic extractor 302 may provide this value to a third comparator 501 and a fourth comparator 515. The third comparator 501 may detect high levels of SAD0. As shown in FIG. 5, the third comparator 501 may identify SAD0 values between limits defined by two threshold values SP0 and SP1. SP0 and SP1 may be predetermined or adaptively generated (e.g., based on a characteristic of the image or device settings). As shown, SP0 is 15 and SP1 is 260. The detection may be consolidated by a third AR context-based binary filter 502. As shown, the third AR context-based binary filter is a 3×3 filter. In some implementations, the third AR context-based binary filter 502 may have other dimensions such as 2×2, 3×4, or 8×8. The consolidated result may be combined via the AND gate 517 with the signals LLV(\vec{u}) and LBF(\vec{u}) constitute another local block-based characteristic map LBC1(\vec{u}). The characteristic signal LBC1(\vec{u}) and the detected local flat zone signal LBF(\vec{u}) may be provided to the image-based TLV detector 303.

The fourth comparator 515 may be configured to generate a value indicative of a flashing scene. The fourth comparator 515 may generate the value based at least in part on the zero motion estimation error SAD0(\vec{u}) as compared with a threshold SP2. In some implementations, the threshold SP2 may be a higher value relative to value of the threshold SP1. For example, in the implementation shown, SP2 is equal to 120. SP0 and SP1 may be predetermined or adaptively generated (e.g., based on a characteristic of the image, based on SP1, or based on device settings). Combining the comparison result together with the signals LLV(\vec{u}) and LBF(\vec{u}), another local block-based characteristic map LBC2(II) may be generated. This characteristic information LBC2(\vec{u}) may be provided to the local-global TLV detector 304.

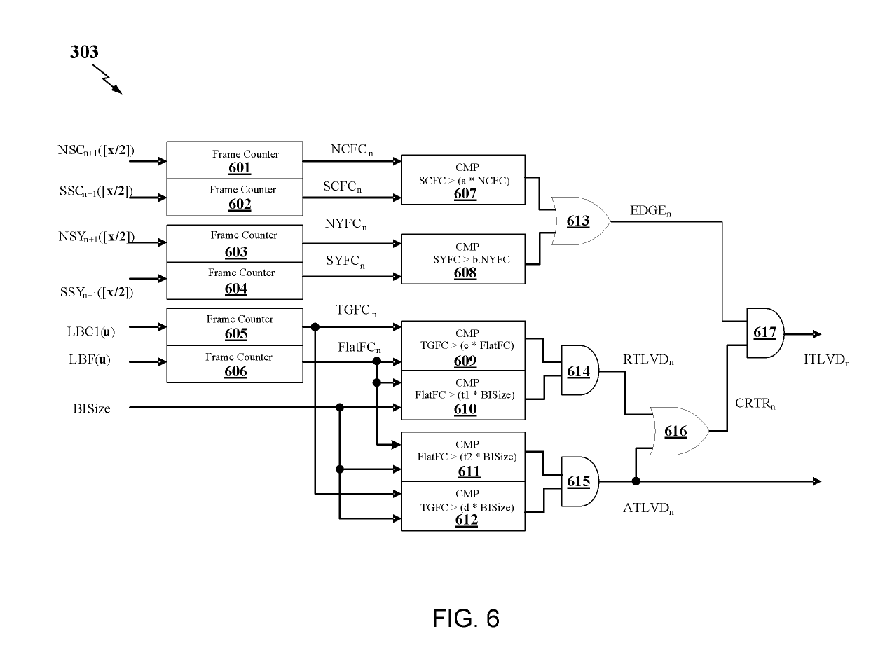

FIG. 6 illustrates a functional block diagram of an example of an image-based TLV detector. For frame-based decisions, the image-based TLV detector 303 may include frame-based counters coupled with comparators and combinatory logic units. Each of the six input signals of the image-based TLV detector 303, namely NSCₙ₊₁([\vec{x}/2]), SSCₙ₊₁([\vec{x}/2]), NSYₙ₊₁([\vec{x}/2]), SSYₙ₊₁([\vec{x}/2]), LBC1(\vec{u}) and LBF(\vec{u}), may be provided to one or more frame-based counters. As shown in FIG. 6, the image-based TLV detector 303 includes six frame-based counters 601, 602, 603, 604, 605, and 606, each counter corresponding to an input signal. The values generated by the counters may indicate the pixel numbers in the frame (n+1) of each binary input signal or characteristic associated with the corresponding input signal. As shown in FIG. 6, the six result value notations are respectively: NCFCₙ, SCFCₙ, NYFCₙ, SYFCₙ, TGFCₙ and FlatFCₙ. At the end of the frame, these results can be frame-based delayed and correlated to the frame (n) for FRC timing synchronization. .

Two parameters shown in FIG. 6, NCFCₙ and SCFCₙ, correspond respectively to a new color contour frame count and a still color contour frame count. The image-based TLV detector 303 may include a first comparator 607 configured to generate a value based at least in part on the NCFCₙ and SCFCₙ values. As shown, the first comparator 607 may be configured to compare the values to detect TLV and to differentiate the case of normal moving pictures which can be handled by the FRC. The comparison may include the determination shown in Equation 15.

SCFC>(a*NCFC) (15)

where a is a coefficient value. For example, the value of a may be given as 32/64. In some implementations, the value of a may be a different value or adaptively generated (e.g., based on a characteristic of the image or device settings).

Similarly, the two frame counts NYFCₙ and SYFCₙ corresponding respectively to new luminance contour and still luminance contour may be compared by a similarly configured second comparator 608. The second comparator 608 may be configured to include the determination shown in Equation 16.

SYFC>(b*NYFC) (16)

These two decisions from the first comparator 607 and the second comparator 608 may be combined via an OR gate 613 to generate a TLV condition value based on edge information, identified as EDGEₙ in FIG. 6.

The parameters for temporal gradient region frame count (TGFCₙ) and flat region frame count (FlatFCₙ) may be provided to a third comparator 609. The third comparator 609 may be configured to compare the temporal gradient region frame count to the flat region frame count for each frame. As shown, the third comparator 609 is configured to determine whether the temporal gradient region frame count for the frame is greater than the flat region frame count.

The image-based TLV detector 303 may include a fourth comparator 610. The fourth comparator 610 may be configured to obtain and compare a block-based image size (BISize) and the flat region frame count. The BISize may be an absolute value parameter (e.g., positive value). As shown, the fourth comparator 610 may be configured to determine whether the flat region frame count is greater than the block-based image size. A fifth comparator 611 may be included which is similarly configured as the fourth comparator 610. However, the output of the fifth comparator 611 may be provided for a different determination than the output of the fourth comparator 610.

A sixth comparator 612 may be included. The sixth comparator 612 may be configured to compare the temporal gradient region frame count with the block-based image size. As shown in FIG. 6, the sixth comparator 612 is configured to determine whether the TGFC is greater than the block-based image size.

In some implementations, if the dimensions of the reduced resolution image RIₙ(\vec{x}) are M_{R} N_{R}, the BISize may be expressed as (M_{R}N_{R})/(WW). The comparison relations implemented by the comparators 609, 610, 611 and 612, between TGFCₙ, FlatFCₙ and BISize may be respectively summarized by the following Equations (17)-(20):

TGFC>(c*FlatFC) (17)

FlatFC>(t1*BISize) (18)

FlatFC>(t2*BISize) (19)

TGFC>(d*BISize) (20)

where c, t1, t2, and d are constant coefficient values. In the implementation shown, the coefficients b, c, t1, t2 and d are given as b=32/64, c=4/64, t1=59/64, t2=48/64 and d=15/64 respectively.

The relation shown in Equation (17) indicates that the detected temporal gradient zone (TLV zone), should be superior to some portion of the detected flat zone. The last three relations shown in Equations (18), (19) and (20) generate a value indicating a relationship between the sizes of TGFC and FlatFC relative to the block-based image size.

The results of the third comparator 609 and the fourth comparator 610 (e.g., relations shown in Equations (17) and (18)), may be combined via a first AND gate 614 to provide a relative TLV decision (RTLVDₙ). Similarly, the results of the fifth comparator 611 and the sixth comparator 612 (e.g., relations shown in Equations (19) and (20)) may be combined via a second AND gate 615 to provide an absolute TLV decision (ATLVDₙ). The decision may be absolute in the sense that the decision may be generated based on the two comparisons with the absolute number of the block-based image size.

The two decisions RTLVDₙ and ATLVDₙ may in turn be combined via a second OR gate 616 to generate CRTRₙ a value indicative of TLV characteristics. Combining the information of EDGEₙ, and CRTRₙ via a third AND gate 617 may yield an image-based TLV decision ITLVDₙ value. This value may be provided to the pixel-based TLV localizer 305. The ATLVDₙ decision value may be provided to the local-global TLV detector 304 for further processing.

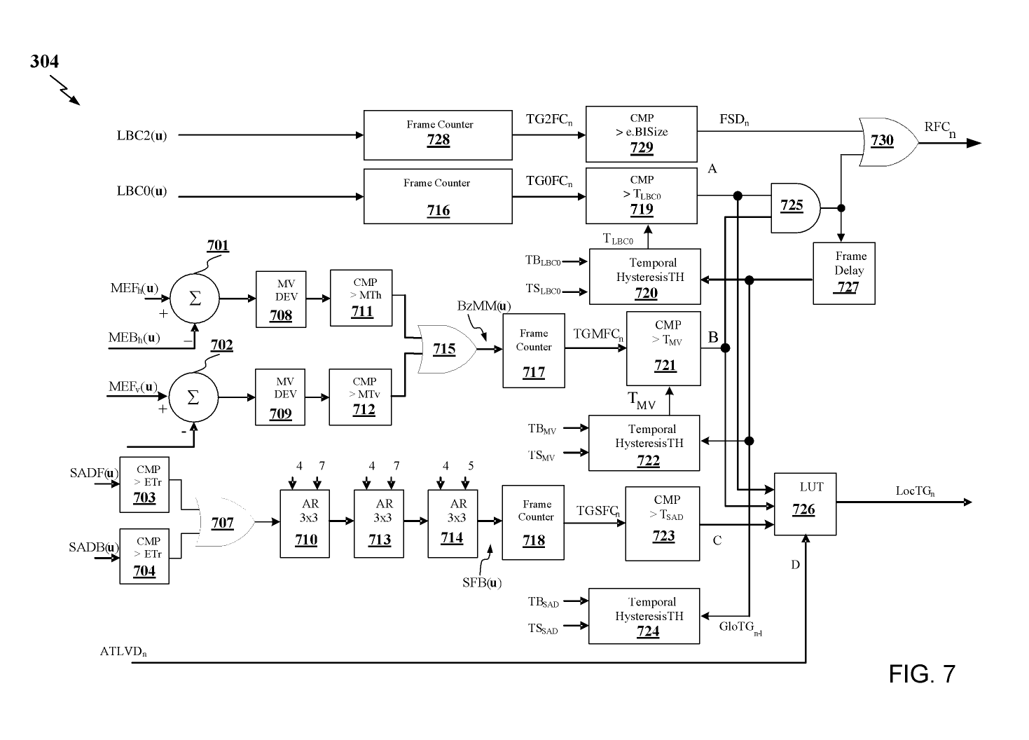

FIG. 7 illustrates a functional block diagram of an example of a block-based local-global detector for image-based decision. The block-based local-global detector TLV 304 obtains parameters such as forward and backward blocked-based motion vectors (MEF and MEB), the associative errors (e.g., SAD) associated with the vectors, and characteristics LBC0, LBC2 or decision signal ATLVD.

In the implementation shown in FIG. 7, the horizontal components of motion Vectors MEF and MEB may be grouped together via a first adder 701. The inverter (noted using a negative sign) applied for MEBₕ before the first adder 701 may be included to produce a result value that indicates the total global motion. In some implementations, forward and backward MVs are generally opposed in direction. As shown, the backward vector is negatively signed, thus by inverting the backward vector, the first adder 701 result output may represent a global forward and backward MV. In some implementations, the absolute value of each vector may be provided to the first adder 701. The value generated by the first adder 701 may be provided to a motion vector deviation calculator (MVDEV) 708 which provides a metric to measure local MV variation.

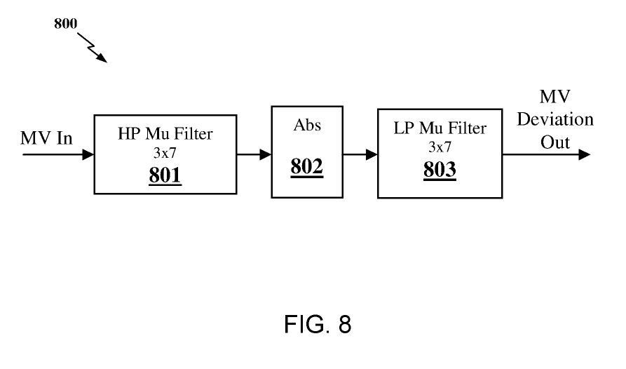

FIG. 8 shows a functional block diagram of an example of a motion vector deviation calculator. The motion vector deviation calculators MVDEV 708 and 709 may be implemented similarly to the motion vector deviation calculator 800 shown in FIG. 8. The motion vector deviation calculator 800 includes a high pass (HP) Mu filter 801, an absolute value detector 802 and a low pass (LP) Mu filter 803. As shown in FIG. 8, the high pass Mu filter and low pass Mu filter are 3×7 filters. In some implementations, the HP Mu filter 801 is a complementary of the LP Mu filter 803. The configuration shown may be used to estimate the local mean motion vector. To reduce compression artifacts (such as the Gibbs effect), the HP Mu filter 801 may be configured to include the impulse response shown in Equation 21.

$$hpmu = ( \begin{matrix}1 & 1 & 2 & 2 & 2 & 1 & 1 \\ 1 & 2 & 2 & - 30 & 2 & 2 & 1 \\ 1 & 1 & 2 & 2 & 2 & 1 & 1\end{matrix} ) / 32 \qquad ( 21 )$$

The HP Mu filter 801 may be coupled with the absolute value detector 802. The absolute value detector 802 may be configured to provide strength of the variation of motion vector's component. The LP Mu filter 803 may be coupled with the absolute value detector 802. The LP Mu filter 803 may be configured to estimate the mean the local strength MV deviation of the provided strength variation. The LP Mu filter 803 may be configured to include the impulse response given as in Equation 22.

$$lmpu = ( \begin{matrix}1 & 1 & 2 & 2 & 2 & 1 & 1 \\ 1 & 2 & 2 & 2 & 2 & 2 & 1 \\ 1 & 1 & 2 & 2 & 2 & 1 & 1\end{matrix} ) / 32 \qquad ( 22 )$$

Referring again to FIG. 7, a local estimate metric of MV horizontal component deviation may be provided by motion vector deviation calculator 708. To detect an unusual or “bizarre” motion, this value may be obtained by a horizontal comparator 711. The horizontal comparator 711 may be configured to compare the obtained value to a horizontal motion threshold (MTh). Similarly, the same procedure may be implemented for the vertical components of MEF and MEB via a second adder 702, MVDEV 709 and a vertical comparator 712. The vertical comparator 712 may be configured to compare the obtained value to a vertical motion threshold (MTv). The value of the motion thresholds MTh and MTv may be pre-determined or dynamically configured (e.g., based on information associated with the image or device settings). In some implementations, the MTh may be configured to 20. In some implementations, the MTv may be configured to 17. The values generated by the horizontal comparator 711 and the vertical comparator 712 may be combined together via an OR gate 715 which yields a block-based bizarre motion map (BzMM(\vec{u})).

In some implementations, the forward and backward ME errors (e.g., SADF and SADB) may be combined together and used for TLV detection. The combined values (SADF or SADB) may each be compared via a third comparator 703 and a fourth comparator 704, respectively, with an error threshold value (ETr). As shown in FIG. 7, the error threshold value is 32. However, in some implementations, the error threshold value may be adaptively determined (e.g., based on the image data). As shown in FIG. 7, the same error threshold is used for both the third comparator 703 and the fourth comparator 704. In some implementations, distinct error threshold values may be used for each of the third comparator 703 and the fourth comparator 704.

The value generated by the third comparator 703 and the value generated by the fourth comparator 704 may be grouped together via OR gate 707. The grouped value generated by the OR gate 707 may be provided to three successive binary add remove filters 710, 713, and 714. As shown, the binary add remove filters are three by three (3×3) filters. In some implementations, one or more of the filters may be, for example, a 2×2 filter, a 4×4 filter, or a 2×4 filter. The filters 710, 713 and 714 may be configured with indicated thresholds for decision consolidation. The value generated by the last consolidation AR filter 714 (SFB(\vec{u})) represents the detected high value map of SADF or SADB.

The local block-based characteristic (LBC2(\vec{u}) may be provided to a first frame counter 728. The local block-based characteristic (LBC0(\vec{u}) may be provided to a second frame counter 716. The block-based bizarre motion map (BzMM(\vec{u})) may be provided to a third frame counter 717. The detected high value map of SADF or SADB (SFB(\vec{u}) may be provided to a fourth frame counter 718. The frame counters 728, 716, 717, and 718 may be frame-based counters. One or more of the frame counters 728, 716, 717, and 718 may be configured to also indicate delays.

The frame counters 728, 716, 717, and 718 may be configured to provide the following frame counts TG2FCₙ, TG0FCₙ, TGMFCₙ and TGSFCₙ, respectively. Each frame counter 728, 716, 717, and 718, as shown in FIG. 7, is coupled with a comparator. The frame counter 728 is coupled with a first count comparator 729. The first count comparator 729 may be configured to compare the TG2 FCn frame count with the block-based image size (BISize). As shown in FIG. 7, the block-based image size is multiplied by a coefficient (e). The first count comparator 729 may be configured to compare based, at least in part, on Equation 23.

TG2FC>e*BISize (23)

The frame counter 716 is coupled with a second count comparator 719. The second count comparator 719 may be configured to compare the TG0FCₙ frame count with a threshold (T_{LBC0}) In the implementation shown in FIG. 7, the second count comparator 719 may compare based in part on Equation (24). The detected pixel number TG2FC of the characteristic-2 map LBC2(u) should be big enough when compared to a fraction of block-based image size.

In one implementation, the value of coefficient e utilized may be 32/64. The coefficient e may be predetermined, or adaptively determined (e.g., based on information associated with the image or device settings). As configured, LBC2(u) may correspond eventually to flashing of a scene detection (FSDₙ) and Equation (23) may indicate that at least half of the scene is affected by TLV. The first comparator 729 provides an output value FSDₙ. The output value FSD may be provided to an OR gate 730.

The frame counter 716 is coupled with a second count comparator 719. The second count comparator 719 may be configured to compare the TG0FCₙ frame count with a threshold (T_{LBC0}) In the implementation shown in FIG. 7, the second count comparator 719 may compare based in part on Equation (24).

TG0FC>T_{LBC0} (24)

The threshold (T_{LBC0}) may be provided by a first temporal hysteresis (TH) threshold generator 720. The first temporal hysteresis threshold generator 720 may be configured to generate the threshold (T_{LBC0}) based at least in part on, Equation (25).

T_{LBC0}=TB_{LBC0}+(TS_{LBC0}−TB_{LBC0})*GloTGₙ₋₁ (25)

where TB_{LBC0} is a threshold value for the local block-based characteristic LBC0, and

TS_{LBC0} is a second threshold value for the local block-based characteristic LBC0, and

GloTGₙ₋₁ is a value indicating a global temporal gradient of luminance for a previous frame.

As shown in FIG. 7, the global temporal gradient of luminance for a previous frame may be provided by a frame delay 727. The threshold values (T_{LBC0} and TS_{LBC0}) may be determined based on information similar to that which is included in Table 2 below.

The frame counter 717 is coupled with a third count comparator 721. The third count comparator 721 may be configured to compare the TGMFCₙ frame count with a threshold (T_{MV}). In the implementation shown in FIG. 7, the third count comparator 721 may compare based in part on Equation (26).

TGMFCₙ>T_{MV} (26)

The threshold (T_{MV}) may be provided by a second temporal hysteresis threshold generator 722. The second temporal hysteresis threshold generator 722 may be configured to generate the threshold (T_{MV}) based at least in part on, Equation (27).

T_{MV}=TB_{MV}+(TS_{MV}−TB_{MV})* GloTGₙ₋₁ (27)

where TB_{MV} is a threshold value for the motion vector, and

TS_{MV} is a second threshold value for the motion vector, and

GloTGₙ₋₁ is a value indicating a global temporal gradient of luminance for a previous frame.

As shown in FIG. 7, the global temporal gradient of luminance for a previous frame may be provided by a frame delay 727. The threshold values (TB_{MV} and TS_{MV}) may be determined based on information similar to that which is included in Table 2 below.

The frame counter 718 is coupled with a fourth comparator 723. The fourth comparator 723 may be configured to compare the TGSFCₙ frame count with a threshold (T_{SAD}). In the implementation shown in FIG. 7, the fourth count comparator 719 may compare based in part on Equation (28).

TGSFCₙ>T_{SAD} (28)

The threshold (T_{SAD}) may be provided by a third temporal hysteresis threshold generator 724. The third temporal hysteresis threshold generator 724 may be configured to generate the threshold (T_{SAD}) based at least in part on, Equation (29).

T_{SAD}=TB_{SAD}+(TS_{SAD}−TB_{SAD})*GloTGₙ₋₁ (29)

where TB_{SAD} is a threshold value for the sum of absolute differences, and

TS_{SAD} is a second threshold value for the sum of absolute differences, and

GloTGₙ₋₁ is a value indicating a global temporal gradient of luminance for a previous frame.

As shown in FIG. 7, the global temporal gradient of luminance for a previous frame may be provided by a frame delay 727. The threshold values (TB_{SAD} and TS_{SAD}) may be determined based on information similar to that which is included in Table 2 below.

In Equation (23), the threshold may be a single value. Inversely, the thresholds T_{LBC0}, T_{MV} and T_{SAD} in Equations (24), (25) and (26), respectively for the characteristic-0, the motion vector variation and the error SAD, may be expressed as double values: a big threshold value (TB) and a small threshold value (TS), the threshold values selected by a temporal hysteresis TH device.

The following table summarizes the thresholds TB and TS which may be utilized in the previous equations:

TABLE 2
Hysteresis Threshold Values

| Threshold | LBC0 | MV | SAD |
|---|---|---|---|
| TB | (21/64) * BISize | (20/64) * BISize | (19/64) * BISize |
| TS | (17/64) * BISize | (16/64) * BISize | (15/64) * BISize |

As shown in FIG. 7, A, B and C may represent the respective outputs of the comparators 719, 721, and 723. D may represent the signal ATLVD provided from the image based TLV detector 303.

A and B may be combined via an AND gate 725 to generate GloTG a value indicating the global temporal gradient of luminance for the current frame. The TLV or TG effect may be identified as global to a whole scene if the detected local block based characteristic-0 (LBC0(\vec{u})) and the detected MV variation each comprise at least a quarter of the area of a scene. The OR gate 730 may combine GloTGₙ and the FSDₙ to generate a value RFCₙ indicating the frame as a repeat frame for correction.

The frame-based delayed version of the global decision GloTGₙ (GloTGₙ₋₁) may be used for controlling the above described temporal hysteresis TH.

The four binary signals A, B, C, and D may be provided to a local temporal gradient of luminance generator 726. The local temporal gradient of luminance generator 726 may be configured to provide the image-based decision of local temporal gradient of luminance (LocTGₙ) for correction. The local temporal gradient of luminance generator 726 may be configured to implement the logic given by the following look up table (LUT):

TABLE 3
LUT for LocTGₙ

| A | B | C | D | LocTGₙ |
|---|---|---|---|---|
| 0 | 0 | 0 | 0 | 1 |
| 0 | 0 | 0 | 1 | 1 |
| 0 | 0 | 1 | 0 | 0 |
| 0 | 0 | 1 | 1 | 1 |
| 0 | 1 | 0 | 0 | 0 |
| 0 | 1 | 0 | 1 | 0 |
| 0 | 1 | 1 | 0 | 1 |
| 0 | 1 | 1 | 1 | 1 |
| 1 | 0 | 0 | 0 | 0 |
| 1 | 0 | 0 | 1 | 0 |
| 1 | 0 | 1 | 0 | 1 |
| 1 | 0 | 1 | 1 | 1 |
| 1 | 1 | 0 | 0 | 0 |
| 1 | 1 | 0 | 1 | 0 |
| 1 | 1 | 1 | 0 | 0 |
| 1 | 1 | 1 | 1 | 0 |

The LUT may be provisioned to the device and stored in memory for use by the local temporal gradient of luminance generator 726. In some implementations the local temporal gradient of luminance generator 726 may calculate the gradient based on for example, information associated with the video data. The signal LocTG as well as ITLVD may be provided to the pixel based TLV localizer 305.

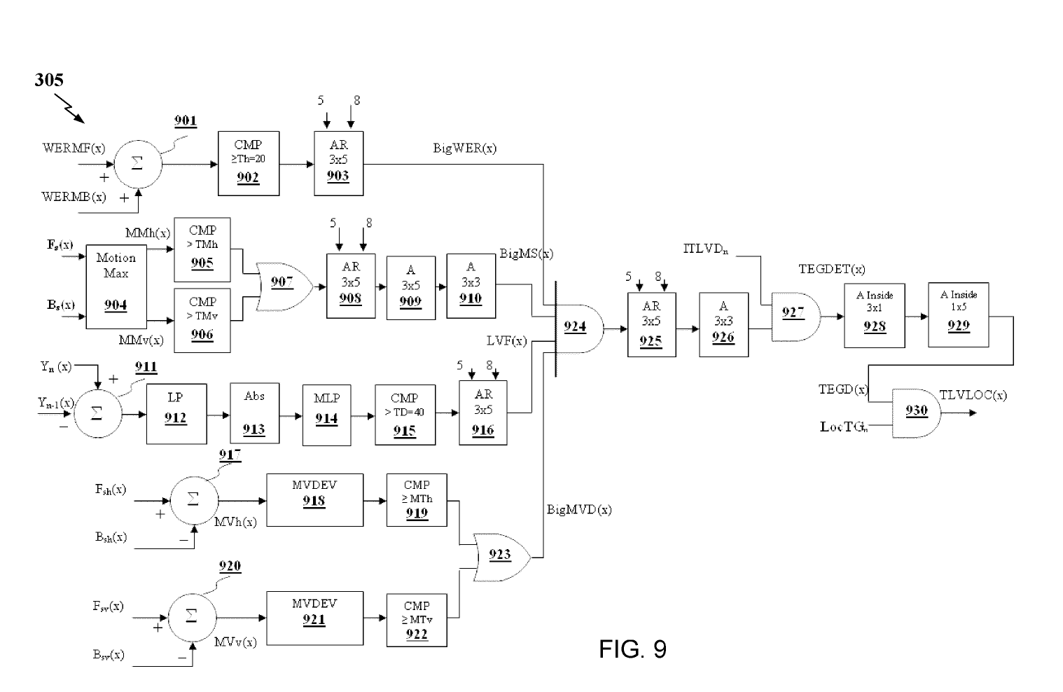

FIG. 9 illustrates a functional block diagram of an example of a local-global TLV detector. To locate a pixel-based TLV artifact, the local-global TLV detector 305 may be configured to detect four conditions at a given pixel x: (a) big ME error, (BigWER(\vec{x})); (b) big MV Strength (BigMS(\vec{x})); (c) luminance variation in flat region (LVF(\vec{x})); and (d) big MV Deviation (BigMVD(\vec{x})).

The first condition BigWER(\vec{x}) may be detected by adding, via a first adder 901, the forward and backward ME errors, WERMF(\vec{x}) and WERMB(\vec{x}) respectively. The result of the first adder 901 may be provided to a first comparator 902. The first comparator 902 may be configured to compare the provided result with a threshold. As shown in FIG. 9, the first comparator 902 is configured to determine if the provided value is greater than or equal to a threshold (Th). The threshold (Th) may be predetermined (e.g., a value of 20 as shown), or dynamically generated (e.g., based on information associated with the image or device settings). The result of the comparison may be provided to a binary add remove filter 903. The add remove filter 903 may be configured to consolidate the results. In the example shown, the add remove filter is a 3×5 filter. The thresholds for the add remove filter 903 are shown as 5 and 8. However, in other implementations, the thresholds may be different (e.g., 4, 7, 10, 2). The consolidated result will be a value indicating the magnitude of the ME error (BigWER(\vec{x})).

To generate the second condition BigMS(\vec{x}), a selector 904 is included. The selector may be configured to select the maximum horizontal and vertical components strengths (MMh(\vec{x})) and MMv(\vec{x}), respectively) between the forward and backward motion vectors (Fₛ(\vec{x}) and Bₛ(\vec{x}), respectively). The value MMh for a give pixel (X) may be generated based at least in part on Equation (30).

MMₕ=Max(|F_{Sh}|, B_{Sh}|) (30)

where Fₛₕ is a value indicating the forward horizontal motion vector, and

Bₛₕ is a value indicating the backward horizontal motion vector.

The value MMh(\vec{x}) may be provided to a second comparator 905. The second comparator 905 may be configured to compare the value MMh(\vec{x}) with a horizontal threshold. The threshold may be predetermined (e.g., 10, 12, 9) or dynamically generated (e.g., based on information associated with the image or device settings). The result of the comparison may be provided to an OR gate 907.

The value of MMv for a given pixel (\vec{x}) may be generated based at least in part on Equation (31).

MMᵥ=(19/16) max(|Fₛᵥ|, |Bₛᵥ|) (31)

where Fₛᵥ is a value indicating the forward vertical motion vector, and

Bₛᵥ is a value indicating the backward vertical motion vector.

The value MMv(\vec{x}) may be provided to a third comparator 906. The third comparator 906 may be configured to compare the value MMv(\vec{x}) with a vertical threshold. The threshold may be predetermined (e.g., 8, 10, 7) or dynamically generated (e.g., based on information associated with the image or device settings). The result of the comparison may be provided to the OR gate 907.

The result value generated by the OR gate 907 may be consolidated via appropriate binary add-reduce and add filters 908, 909, and 910 to generate a BigMS(\vec{x}) map. As shown, the dimensions of logical filters 908, 909, and 910 are (3×5), (3×5), and (3×3). However, other dimensions for the logical filters may be applied depending on the implementation. Furthermore, the thresholds for the AR filter 908 are given in the figure as 5 and 8.

The third condition indicative of luminance variation in flat region (LVF(\vec{x})) can be generated for a given pixel (\vec{x}). An adder 911 may be configured to generate the difference between the present image luminance for the given pixel (Yₙ(\vec{x})) and the previous image luminance for the given pixel (Yₙ₋₁(\vec{x})). The result may be provided to a low-pass filter 912. The LP filter 912 may include the impulse response of Equation (32).

$$lp 912 = ( \begin{matrix}1 & 1 & 1 \\ 1 & 1 & 1 \\ 1 & 1 & 1\end{matrix} ) / 8 \qquad ( 32 )$$

An absolute value circuit 913 may obtain the low-pass filtered result and generate a value indicating the magnitude of the low-passed image difference. The value generated by the absolute value circuit 913 may be filtered via MLP filter 914. The MLP filter 914 may include the impulse response of Equation (33).

$$mlp 914 = ( \begin{matrix}3 & 4 & 3 \\ 4 & 4 & 4 \\ 3 & 4 & 3\end{matrix} ) / 4 \qquad ( 33 )$$

The filtered result may be provided to a comparator 915. The comparator 915 may be configured to compare the filter result value generated by filter 914 to a threshold (TD). For example, the threshold may be preconfigured (e.g., 40) or dynamically generated (e.g., based on information associated with the image or device settings). As shown, the comparator 915 is configured to generate a value indicating whether the filtered value is greater than the threshold. The result of the comparison may be provided to an add-reduce filter 916 for consolidation. The AR filter 916 may be a binary (3×5) AR filter. The thresholds for the AR filter 916 shown in FIG. 9 are 5 and 8. In some implementations, the thresholds may be other values (e.g., 2 and 3, 4 and 7, 5 and 9) and/or dynamically generated (e.g., based on information associated with the image or device settings). The filtered result will be a value indicating luminance variation in flat region (LVF(x)) for the pixel of interest (\vec{x}).

To generate the fourth condition value indicating large motion vector deviation (BigMVD(\vec{x})) for a given pixel (\vec{x}), adders 917 and 920 are provided. The adder 917 may be configured to generate the different between the forward horizontal vector for the pixel (Fₛₕ(\vec{x})) and the backward horizontal vector for the pixel (Bₛₕ(\vec{x})). The result (MVh(\vec{x})) may be provided to a deviation generator 918. The deviation generator 918 may be configured to estimate the deviation of the horizontal motion vector. The deviation estimate may be provided to a comparator 919. The comparator 919 may be configured to compare the deviation estimate to a threshold. As shown, the comparator 919 is configured to determine whether the deviation estimate is greater than or equal to a threshold (MTh). The threshold may be a static value (e.g., 3, 10, or 20) or dynamically generated (e.g., based on information associated with the image or device settings). The result of the comparison may be provided to an OR gate 923.

The adder 920 may be configured to can be configured to generate the different between the forward vertical vector for the pixel (Fₛᵥ(\vec{x})). and the backward vertical vector for the pixel (Bₛᵥ(\vec{x})). The result (MVv(\vec{x})) may be provided to a deviation generator 921. The deviation generator 921 may be configured to estimate the deviation of the vertical motion vector. The deviation estimate may be provided to a comparator 922. The comparator 922 may be configured to compare the deviation estimate to a threshold. As shown, the comparator 922 is configured to determine whether the deviation estimate is greater than or equal to a threshold (MTv). The threshold may be a static value (e.g., 3, 10, or 20) or dynamically generated (e.g., based on information associated with the image or device settings). The result of the comparison may be provided to the OR gate 923.

If either the horizontal or vertical comparisons provide an indication of large motion vector deviation for the pixel, the OR gate 923 may be configured to provide a positive indication for this characteristic as the value for BigMVD(\vec{x}).

The results of the four conditions namely BigWER(\vec{x}), BigMS(\vec{x}), LVF(\vec{x}) and BigMVD(\vec{x}) may be combined together via an AND gate 924 to generate a preliminary detection of TLV artifact location. This detection may be somewhat isolated or discontinuous. In some implementations, the detection may be further processed to accommodate this result. As shown in FIG. 9, an add-remove filter 925 is provided. The add-remove filter 925 may be a (3×5) AR filter. The thresholds for the AR filter 925 shown in FIG. 9 are 5 and 8. In some implementations, the thresholds may be other values (e.g., 2 and 3, 4 and 7, 5 and 9) and/or dynamically generated (e.g., based on information associated with the image or device settings). A subsequent add filter 926 may also be included. The add filter, as shown in FIG. 9, is a 3×3 add filter.

The consolidated result may be validated via an AND gate 927. The validation may include an enable decision signal (ITLVDₙ) which may be provided by the image TLV detector 303.

In some implementations, the validation result (TEGDET(\vec{x})) may not be compact. In such implementations, additional processing may be included. For example, two add-inside filters 928 and 929 of respective dimension (3×1) and (1×5) may be used for the hole-filling process. The vertical add-inside (3×1) filter 928 may be configured to generate a signal similar to that generated by Equation (34).

$$Out ( {x}^{->} ) = \{ \begin{matrix}1 , & if In ( {x}^{->} ) = 1 or ( In ( c , r - 1 ) = 1 and In ( c , r + 1 ) = 1 ) \\ 0 , & if else\end{matrix} \qquad ( 34 )$$

The horizontal add-inside (1×(2K+1)) filter 929 may be configured to generate a signal defined by Equation (35).

$$Let Lc ( {x}^{->} ) = {{⋃}_{n = 1}}^{K} In ( c - n , r ) and Rc ( {x}^{->} ) = {{⋃}_{n = 1}}^{K} In ( c + n , r ) \\ Out ( {x}^{->} ) = \{ \begin{matrix}1 , & if In ( {x}^{->} ) = 1 or ( LC ( {x}^{->} ) = 1 and RC ( {x}^{->} ) = 1 ) \\ 0 , & if else\end{matrix} \qquad ( 35 )$$

In these Equations (34) and (35), In(\vec{x}) and Out(\vec{x}) denote, respectively, the filter input and output at the pixel Ft which is given may, in some implementations, be expressed in terms of column and row location values.

The result (TEGD(\vec{x})) may be enabled via AND gate 930 in conjunction with the decision LocTGₙ provided previously from block-based local-global TLV detector 304. The output of the AND gate 930 may be a value representing the TLVLOC(\vec{x}) map which may be used to localize the TLV artifact to be corrected.

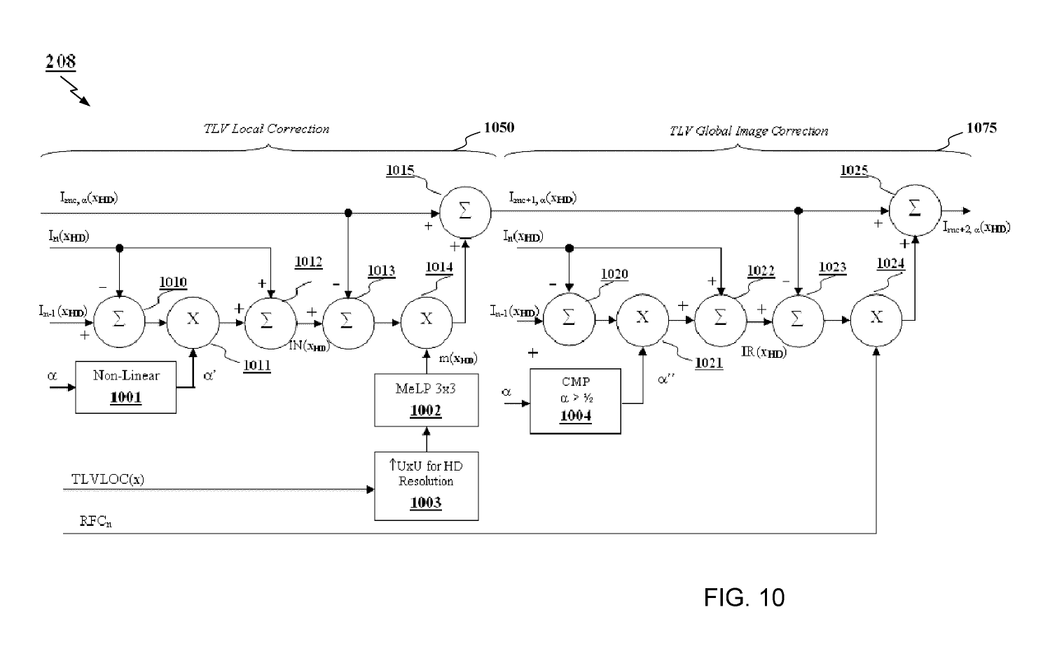

FIG. 10 illustrates a functional block diagram of an example of a TLV correction circuit. The TLV correction circuit 208 may include two parts: a first part for TLV local correction 1050 and a second part for TLV global image correction 1075.

The TLV local correction part 1050 may provide a soft blending between the normal MC interpolated image I_{mc,α}(\vec{x}_{HD}) generated by the HDME/HDMC 206 and a nonlinear interpolated image IN(\vec{x}_{HD}) generated by an adder 1012. The nonlinear interpolated image IN(\vec{x}_{HD}) may generated based on the two existing input images Iₙ(\vec{x}_{HD}) and Iₙ₋₁(\vec{x}_{HD}).

To generate the nonlinear interpolated image, in some implementations, if alpha (α) denotes the relative distance of the interpolated image (I_{mc,α}(\vec{x}_{HD})) in respect to the position of the present image (Iₙ(\vec{x}_{HD})), instead of an interpolation in linear function of α, the interpolation may be performed in another position (α′) of alpha in a nonlinear manner. A non-linear interpolation circuit 1001 may be configured to generate α′ by the following equation.

$${α}^{′} = \{ \begin{matrix}2 {α}^{2} , & if α < 1 / 2 \\ 1 - 2 {( 1 - α )}^{2} , & if α \geq 1 / 2\end{matrix} \qquad ( 36 )$$

Noting that Equation (36) is a non-linear relation in function only of a single variable α. The relationship of Equation (36) is a function of both alpha and a detected reliability provided from the image difference histogram. When the α′ value is calculated, the image IN(\vec{x}_{HD}), via adder 1010, multiplier 1011, and adder 1012, is generated based on the following expression:

IN(\vec{x}_{HD})=Iₙ(\vec{x}_{HD})+α′(Iₙ₋₁(\vec{x}_{HD})−Iₙ(\vec{x}_{HD})) (37)

To make the blending for local correction, the reduced resolution position map TVLLOC(\vec{x}) is up-sampled via an up-sampler 1003. The up-sampler 1003 may be configured to upsample the reduced resolution position map by a factor UxU for HD resolution where U is an up-sampling quantity. The map generated by the up-sampler 1003 may be provided to a MeLP (3×3) filter 1002 to provide the mixing signal m(\vec{x}_{HD}). The filter 1002 may include an impulse response such as given by:

$$melp = [ \begin{matrix}3 & 4 & 3 \\ 4 & 4 & 4 \\ 3 & 4 & 3\end{matrix} ] / 32 \qquad ( 38 )$$

The TLV locally corrected image denoted as I_{mc+1,α}(\vec{x}_{HD}) may be generated as an output resulting from an adder 1013, a multiplier 1014, and an adder 1015 as illustrated by FIG. 10. The TLV locally corrected image may be generated based on Equation (39).

I_{mc+1,α}(\vec{x}_{HD})=I_{mc,α}(\vec{x}_{HD})+m(\vec{x}_{HD})*(IN(\vec{x}_{HD})−I_{mc,α}(\vec{x}_{HD})) (39)

The second part 1075 may be configured to provide temporal hard mixing between the first corrected image I_{me+1,α}(\vec{x}_{HD}) generated by the adder 1015 and a repeated image IR(\vec{x}_{HD}). The repeated image IR(\vec{x}_{HD}) value may be generated based on the present or the previous input images Iₙ(\vec{x}_{HD}) and Iₙ₋₁(\vec{x}_{HD}). The images may be provided to a first adder 1020. The first adder 1020 may be configured to generate a difference between the two images. This difference may be provided to a multiplier 1021. The multiplier 1021 may be configured to multiply the difference by a binary selection control signal α″.

The binary control signal may be generated by a comparator 1004. The comparator 1004 may generate the binary control signal based on the interpolation plan alpha (α). For example, as shown in FIG. 10, alpha is compared to a fixed value. In the implementation shown, a determination is made as to whether alpha is less than a middle value (such as ½). As such, the binary selection control signal α″ may be set equal to 1 if a is greater than ½ and to 0 otherwise. One of the equations shown in Equation (40) may be implemented to generate the repeated image IR(\vec{x}_{HD}).

$$IR ( {{x}^{->}}_{HD} ) = {I}_{n} ( {{x}^{->}}_{HD} ) + {α}^{″} ( {I}_{n - 1} ( {{x}^{->}}_{HD} ) - {I}_{n} ( {{x}^{->}}_{HD} ) ) , or \\ IR ( {{x}^{->}}_{HD} ) = \{ \begin{matrix}{I}_{n - 1} ( {{x}^{->}}_{HD} ) , & if {α}^{″} = 1 \\ {I}_{n} ( {{x}^{->}}_{HD} ) , & if {α}^{″} = 0\end{matrix} \qquad ( 40 )$$

For example, in FIG. 10, the first adder 1020 coupled with the multiplier 1021 coupled with a second adder 1922 may generate the repeated image IR(\vec{x}_{HD}).

Similarly, an adder 1023, a multiplier 1024, and an adder 1025 as illustrated in FIG. 10, may be configured to generate the TLV globally corrected image denoted as I_{mc+2,α}(\vec{x}_{HD}). An example configuration may be expressed as shown in Equation (41).

$${I}_{mc + 2 , α} ( {{x}^{->}}_{HD} ) = {I}_{mc + 1 , α} ( {{x}^{->}}_{HD} ) + {RFC}_{n} ( IR ( {{x}^{->}}_{HD} ) - {I}_{mc + 1 , α} ( {{x}^{->}}_{HD} ) ) , or \\ {I}_{mc + 2 \cdot α} ( {{x}^{->}}_{HD} ) = \{ \begin{matrix}IR ( {{x}^{->}}_{HD} ) , & if {RFC}_{n} = 1 \\ {I}_{mc + 1 \cdot α} ( {{x}^{->}}_{HD} ) , & if {RFC}_{n} = 0\end{matrix} \qquad ( 41 )$$

Accordingly, the TLV globally corrected image may be provided for presentation or further processing.

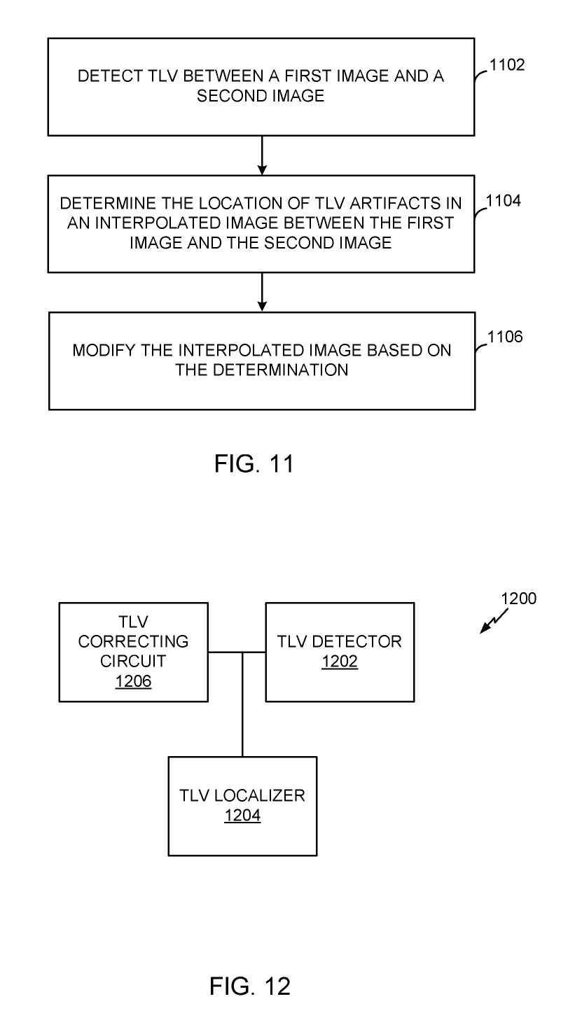

FIG. 11 illustrates a process flow diagram for an example of a method of correcting temporal luminance variation artifacts during frame rate conversion. The method of FIG. 11 may be implemented in whole or in part by one or more of the devices described herein.

The process begins at block 1102 where TLV is detected between a first image and a second image. The detection may be based on edge information for the images, TLV characteristics of the images, and motion estimation between the images. At block 1104, the location of TLV artifacts in an interpolated image between the first image and the second image is determined. At block 1106, the interpolated image may be modified based on the determination. For example, the modification may include local and/or global TLV correction as described above.

FIG. 12 illustrates a functional block diagram of an example apparatus for correcting the temporal luminance variation (TLV) artifacts during frame rate conversion. Those skilled in the art will appreciate that a TLV correction apparatus may have more components than the simplified apparatus 1200 shown in FIG. 12. The apparatus 1200 shown includes only those components useful for describing some prominent features of implementations within the scope of the claims. The apparatus 1200 includes a TLV detector 1202, a TLV localizer 1204, and a TLV correcting circuit 1206.

The TLV detector 1202 may be configured to detect TLV between a first image and a second image based on edge information, TLV characteristics, and motion estimation. The TLV detector 1202 may include one or more of a comparator, a filter, a processor, a logic gate, a memory, and an arithmetic unit. In some implementations, the means for TLV detection may include the TLV detector 1206.

The TLV localizer 1204 may be configured to determine the location of TLV artifacts in an interpolated image between the first image and the second image. The TLV localizer 1204 may include one or more of a comparator, a filter, a processor, a logic gate, a memory, and an arithmetic unit. In some implementations, the means for TLV localizing may include the TLV localizer 1204.

The TLV correcting circuit 1206 may be configured to modify to modify the interpolated image based on the TLV determination. The TLV correcting circuit 1206 may include one or more of a comparator, a filter, a processor, a logic gate, a memory, and an arithmetic unit. In some implementations, the means for modifying an image may include the TLV correcting circuit 1206.

As used herein, the terms “determine” or “determining” encompass a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, the terms “provide” or “providing” encompass a wide variety of actions. For example, “providing” may include storing a value in a location for subsequent retrieval, transmitting a value directly to the recipient, transmitting or storing a reference to a value, and the like. “Providing” may also include encoding, decoding, encrypting, decrypting, validating, verifying, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by an encoding device and/or decoding device as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method of correcting temporal luminance variation (TLV) artifacts during frame rate conversion, comprising:
detecting TLV between a first image and a second image based on edge information, TLV characteristics, and motion estimation information;
determining the location of TLV artifacts in an interpolated image between the first image and the second image; and
modifying the interpolated image based on the determination.

2. The method of claim 1, wherein detecting TLV includes:
receiving a first lower resolution image and a second lower resolution image corresponding to a first image and a second image;
extracting the edge information, wherein extracting the edge information includes extracting edges from the first lower resolution image;
extracting TLV characteristics from the first lower resolution image and the second lower resolution image;
detecting imaged based TLV based on the extracted edges, the identified edges, and TLV characteristics; and
detecting at least one of local TLV and global TLV based on the TLV characteristics, and the motion estimation information, the motion estimation information including motion estimation between the first lower resolution image and the second lower resolution image and motion estimation errors between the first lower resolution image and the second lower resolution image.

3. The method of claim 2, wherein determining the location includes localizing TLV artifacts from pixel-based intensities of the first lower resolution image and the second lower resolution image, pixel-based motion estimation weighted errors, pixel-based motion vectors, delayed image-based decisions, and detected image based TLV and local global TLV.

4. The method of claim 2, wherein the edge information comprises chrominance based edge information and a luminance based edge information.

5. The method of claim 2, wherein the edge information comprises edge information indicating edges included in the first reduced resolution image and comparative edge information indicating whether an edge included in the first reduced resolution image appeared in a reference image.

6. The method of claim 2, wherein extracting the edge information includes comparing a contour strength for a pixel in a selected image and a contour threshold.

7. The method of claim 1, wherein the TLV characteristics are determined based at least in part an error estimation.

8. The method of claim 1, wherein the TLV characteristics include a value indicating a change in a local mean intensity value in a portion of an image.

9. The method of claim 1, wherein the TLV characteristics include a value indicating at least one of a block-based local motion estimation errors and a zero motion estimation error for an image.

10. The method of claim 1, wherein modifying the interpolated image comprises:
non-linearly interpolating moving objects included in the image; and
correcting frame repetition information for the interpolated image based on detecting a global TLV.

11. An apparatus for correcting temporal luminance variation (TLV) artifacts during frame rate conversion, the apparatus comprising:
a TLV detector configured to detect TLV between a first image and a second image based on edge information, TLV characteristics, and motion estimation;
a TLV localizer configured to determine the location of TLV artifacts in an interpolated image between the first image and the second image; and
an image modifier configured to modify the interpolated image based on the determination.

12. The apparatus of claim 11, further comprising:
an edges extractor configured to receive a first reduced resolution image of the first image and to determine edges included in the first reduced resolution image;
a TLV characteristics extractor configured to receive the first reduced resolution image and a second reduced resolution image of the second image and to determine TLV characteristics; and
a local-global TLV detector being coupled with the edge extractor and the TLV characteristics extractor, the local-global TLV detector configured to detect local global TLV based in part on the TLV characteristics,
the TLV localizer being coupled with the local-global TLV detector, the TLV localizer configured to localize TLV artifacts in an interpolated image between the first image and the second image, and
the image modifier being coupled with the TLV localizer, the image modifier configured to modify TLV artifacts in the interpolated image.

13. The apparatus of claim 12, wherein the edges extractor comprises a chrominance based edges extractor and a luminance based edges extractor.

14. The apparatus of claim 11, wherein the edge information comprises edge information indicating edges included in the first resolution image and comparative edge information indicating whether an edge included in the first reduced resolution image appeared in a reference image.

15. The apparatus of claim 12, wherein the edges extractor is configured to determine edges based at least in part on a comparison between a contour strength for a pixel in a selected image and a contour threshold.

16. The apparatus of claim 11, wherein the TLV characteristics are determined based on the received first image, the received second image, and an error estimation.

17. The apparatus of claim 11, wherein the TLV characteristics include a value indicating a change in a local mean intensity value in a portion of the image.

18. The apparatus of claim 11, wherein the TLV characteristics include a value indicating at least one of a block-based local motion estimation errors and a zero motion estimation error for the image.

19. The apparatus of claim 11, wherein localization of the TLV artifact near a pixel is based on luminance information for the pixel, motion vector information for the pixel, and motion estimation errors for the pixel.

20. The apparatus of claim 11, wherein modifying TLV artifacts comprises:
non-linearly interpolating moving objects included in the image; and
correcting frame repetition information for the interpolated image based on detecting a global TLV.

21. A computer readable storage medium comprising instructions executable by a processor of an apparatus, the instructions causing the apparatus to:
detect TLV between a first image and a second image during based on factors based on frame rate conversion information, the factors including edge information, TLV characteristics, and motion estimation information;
determine the location of TLV artifacts in an interpolated image between the first image and the second image; and
modify the interpolated image based on the determination.

22. An apparatus for correcting temporal luminance variation (TLV) artifacts during frame rate conversion, the apparatus comprising:
means for TLV detection configured to detect TLV between a first image and a second image based on edge information, TLV characteristics, and motion estimation;
means for TLV localization configured to determine the location of TLV artifacts in an interpolated image between the first image and the second image; and
means for modifying an image configured to modify the interpolated image based on the determination.
